(19) United States
(12) Patent Application Publication
(10) Pub. No.: US 2018/0081444 A1
(43) Pub. Date: Mar. 22, 2018

(54) SIMULATION SYSTEM

(71) Applicant: FUJITSU LIMITED, Kawasaki-shi (JP)

(72) Inventors: Sachihiro YOUOKU, Isehara (JP); Yasuhiro ENDO, Ebina (JP); Yu NAKAYAMA, Atsugi (JP); Tatsuya SUZUKI, Isehara (JP)

(73) Assignee: FUJITSU LIMITED, Kawasaki-shi (JP)

(21) Appl. No.: 15/801,249

(22) Filed: Nov. 1, 2017

Related U.S. Application Data
(63) Continuation of application No. PCT/JP2015/063524, filed on May 11, 2015.

(51) Int. Cl. G06F 3/01; G06F 3/0346; G06F 3/038

(52) U.S. Cl. CPC G06F 3/016; G06F 3/0346; G06F 3/03547; G06F 2203/0384; G06F 3/038

(57) ABSTRACT

A simulation system includes a display section configured to display an image of an article based on article data representing a shape and coordinates of the article, an operation terminal device including a plurality of dynamic elements which is moved by a user to operate a position of a pointer displayed on the display section, and a data storage section configured to store the article data and vibration data that represents vibration patterns for vibrating the plurality of dynamic elements. Each of the vibration patterns corresponds to a tactile sensation associated with a different part or material of the article. If the pointer has touched the article displayed on the display section, the simulation system drives the plurality of dynamic elements in accordance with a vibration pattern corresponding to a part or a material of the article touched by the pointer.

### CROSS-REFERENCE TO RELATED APPLICATION

This application is a continuation application of International Application PCT/JP2015/063524 filed on May 11, 2015 and designated the U.S., the entire contents of which are incorporated herein by reference.

### FIELD

The embodiments discussed herein relate to a simulation system.

### BACKGROUND

In the related art, a tactile-feedback device for enabling a user to perceive a state of contact with a virtual object is proposed. The tactile-feedback device in the related art includes a plurality of stimulation generating means attached to a user, and a control unit to cause the stimulation generating means to generate stimulations different from each other in accordance with the difference of surfaces of the virtual object being contact with the user (see Japanese Laid-Open Patent Publication No. 2008-108054, for example).

However, the tactile-feedback device in the related art cannot provide different tactile sensations when the user touches to a convex part, a corner, edge, or the like of the virtual object. Nor can the tactile-feedback device provide different tactile sensations according to difference of the materials of the virtual object. That is, the tactile-feedback device in the related art cannot provide a realistic tactile sensation.

The following is a reference document:

### [Patent Document 1] Japanese Laid-Open Patent Publication No. 2008-108054.

### SUMMARY

According to an aspect of the embodiments, a simulation system includes: a display section configured to display an image of an article based on article data representing a shape and coordinates of the article; an operation terminal device including a plurality of dynamic elements, the operation terminal device being configured to be used by a user holding the operation terminal device with a hand to operate a position of a pointer displayed on the display section by moving the operation terminal device; a data storage section configured to store the article data and vibration data that represents vibration patterns for vibrating the plurality of dynamic elements, each of the vibration patterns corresponding to a tactile sensation associated with a different part or a different material of the article; a first detecting section configured to detect a position and an orientation of the operation terminal device; a second detecting section configured to calculate coordinates of the pointer displayed on the display section, based on the position and the orientation of the operation terminal device; a determining section configured to make a determination whether the pointer has come in contact with the article displayed on the display section, based on the coordinates included in the article data and the coordinates of the pointer detected by the second detecting section; and a drive controlling section configured to drive the plurality of dynamic elements which are driven in accordance with the vibration pattern corresponding to the part or the material of the article touched by the pointer, in response to the determination that the pointer has come in contact with the article.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating a simulation system according to a first embodiment;

FIG. 2 is a perspective view of a computer system to which a processing apparatus of the first embodiment is applied;

FIG. 3 is a block diagram describing a configuration of major parts in a main unit of the computer system;

FIG. 4 is a perspective view illustrating an operation terminal device;

FIG. 5 is a diagram illustrating a vibration motor;

FIG. 6 is a diagram illustrating a configuration of an electrical system in the operation terminal device;

FIG. 7 is a diagram illustrating a vibration data;

FIG. 8 is a diagram illustrating article data;

FIG. 9 illustrates an example of images of articles;

FIG. 10 is a table illustrating a time variation of the coordinates of a pointer in an image displayed on a screen;

FIG. 11 is a flowchart describing a process performed in the processing apparatus according to the first embodiment;

FIG. 12 is a diagram illustrating a method of providing a tactile sensation when the pointer touches the article;

FIGS. 13 and 14 are drawings illustrating a relation between a part of the article touched by the pointer and a vibration pattern;

FIGS. 15 and 16 are drawings illustrating a relation between a material of the article touched by the pointer and the vibration pattern;

FIGS. 17 through 21 are drawings illustrating modified examples of the first embodiment;

FIG. 22 is a diagram illustrating a configuration of an electrical system in the operation terminal device;

FIG. 23 is a perspective view illustrating an operation terminal device according to a second embodiment;

FIG. 24 is a diagram illustrating a vibration data according to the second embodiment;

FIG. 25 is a flowchart describing a process performed in a processing apparatus according to the second embodiment;

FIG. 26 is a drawing illustrating a relation between the part of the article touched by the pointer and the vibration pattern;

FIG. 27 is a drawing illustrating a relation between the material of the article touched by the pointer and the vibration pattern; and

FIGS. 28 through 33 are drawings illustrating modified examples of the second embodiment.

### DESCRIPTION OF EMBODIMENT

Hereinafter, simulation systems according to some embodiments of the present disclosure will be described.

### First Embodiment

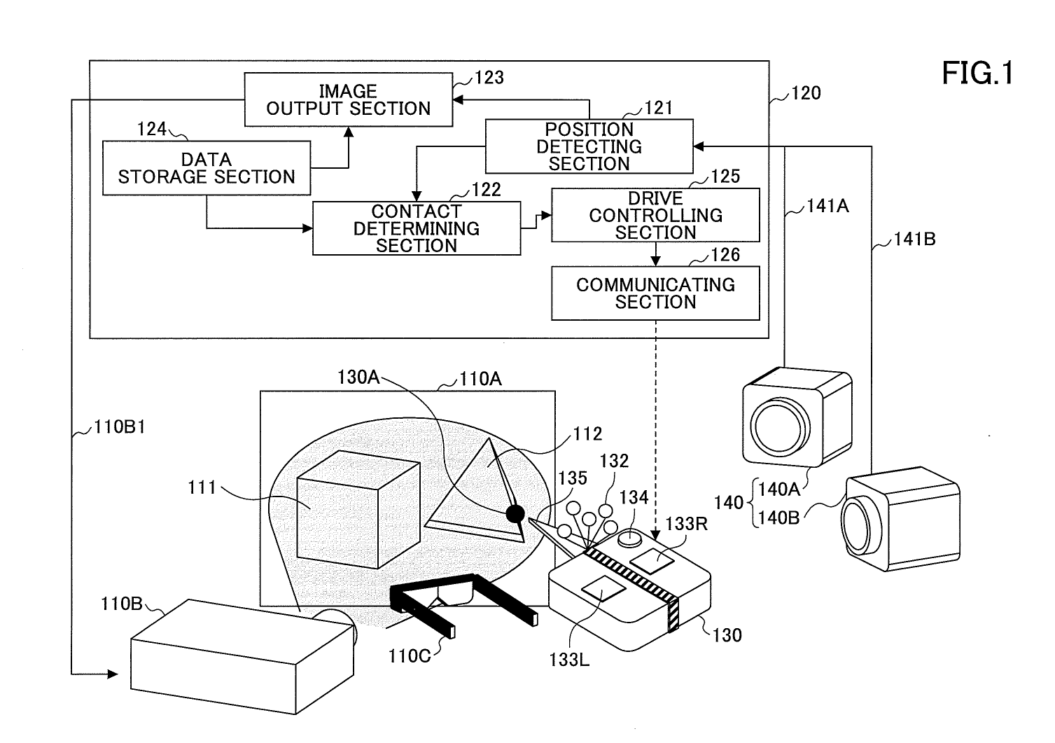

FIG. 1 is a diagram illustrating a simulation system 100 according to a first embodiment.

The simulation system 100 includes a screen 110A, a projecting apparatus 110B, 3 Dimension (3D) glasses 110C, a processing apparatus 120, an operation terminal device 130, and a position measuring apparatus 140.

The simulation system 100 according to the first embodiment can be applied to an assembly support system which is used for grasping assembly workability in a virtual space. In the assembly support system for example, a work for assembling electronic components, such as a CPU (Central

Processing Unit) module, a memory module, a communication module, or connectors, can be simulated in the virtual space.

However, the simulation system 100 according to the first embodiment can be applied not only to the assembly support system but also to various systems for checking workability in a 3-dimensional space.

A screen for a projector can be used as the screen 110A, for example. A size of the screen 110A may be determined as appropriate in accordance with a purpose for using the simulation system 100. On the screen 110A, an image projected by the projecting apparatus 110B is displayed. Here, the case where articles 111 and 112 are displayed on the screen 110A will be described.

The projecting apparatus 110B may be an apparatus that can project images on the screen 110A. For example, a projector can be used as the projecting apparatus 110B. The projecting apparatus 110B is coupled to the processing apparatus 120 through a cable 110B1, to project an image input from the processing apparatus 120 on the screen 110A. The projecting apparatus 110B used in the present embodiment may be a type of apparatus which can project a 3D image (stereoscopic image) on the screen 110A.

Note that the screen 110A and the projecting apparatus 110B are an example of a display section.

A user of the simulation system 100 wears the 3D glasses 110C. The 3D glasses 110C may be a type of glasses which can convert an image projected on the screen 110A by the projecting apparatus 110B into a 3D image. For example, polarized glasses for polarizing incoming light, or LC shutter glasses equipped with liquid crystal shutters can be used.

Note that a liquid crystal display panel may be used instead of the screen 110A and the projecting apparatus 110B, for example. Also, the 3D glasses 110C need not be used when the 3D glasses 110C are not necessary. Further, a head mounted display may be used instead of the screen 110A and the projecting apparatus 110B.

The processing apparatus 120 includes a position detecting section 121, a contact determining section 122, an image output section 123, a data storage section 124, a drive controlling section 125, and a communicating section 126. The processing apparatus 120 may be embodied, for example, by a computer including a memory.

The position detecting section 121 performs image processing such as pattern matching with respect to image data input from the position measuring apparatus 140 to detect a position and an orientation of the operation terminal device 130. The position of the operation terminal device 130 is expressed as coordinates in a 3-dimensional coordinate space, and the orientation of the operation terminal device 130 is expressed as angles to each axis of the 3-dimensional coordinate space.

The position detecting section 121 converts the coordinate values in the three-dimensional coordinate space into coordinate values within an image projected on the screen 110A, and outputs the converted coordinate values, which represent a position of the pointer 130A. The position detecting section 121 is an example of a second detecting section.

Note that the position and the orientation of the operation terminal device 130 may be detected by the position measuring apparatus 140.

The contact determining section 122 determines whether the image of the article 111 or 112 projected on the screen 110A and the pointer 130A of the operation terminal device 130 displayed on the screen 110A are in contact or not.

The contact determining section 122 uses data (article data) that represents a position and a shape of the article 111 or 112 projected on the screen 110A and data that represents the position of the pointer 130A to determine whether the image of the article 111 or 112 and the pointer 130A are in contact or not. The contact determining section 122 is an example of a determining section.

An output terminal of the image output section 123 is coupled to the projecting apparatus 110B through the cable 110B1. The image output section 123 outputs, to the projecting apparatus 110B, an image based on the article data for the articles 111 and 112 stored in the data storage section 124 to display the image on the screen 110A.

Further, the image output section 123 causes the projecting apparatus 110B to display the pointer 130A. The position of the pointer 130A in an image displayed on the screen 110A is determined based on the position and the orientation of the operation terminal device 130 detected by the position detecting section 121.

The data storage section 124 stores article data representing the coordinates and the shapes of the articles 111 and 112, vibration data representing vibration patterns corresponding to tactile sensations associated with the articles 111 and 112, an image data of the pointer 130A, and the like. The data storage section 124 is embodied by a memory, and is an example of a data storage section.

When the contact determining section 122 determines that the image of the article 111 or 112 and the pointer 130A have come in contact, the drive controlling section 125 outputs a driving signal for generating the vibration pattern corresponding to a tactile sensation associated with a part of the article 111 or 112 which the pointer 130A touches. The driving signal is for driving a vibrating element of the operation terminal device 130.

The communicating section 126 is a communicating section that performs wireless communication with the operation terminal device 130. For example, the communicating section 126 can perform wireless communication in compliance with Bluetooth (registered trademark) or Wi-Fi (Wireless Fidelity) standard. The communicating section 126 transmits the driving signal generated by the drive controlling section 125 to the operation terminal device 130. Note that the communicating section 126 may be a communicating section that performs wired communication with the operation terminal device 130.

The operation terminal device 130 is a terminal device that the user using the simulation system 100 holds with his/her hand(s) to control the position of the pointer 130A displayed on the screen 110A. The operation terminal device 130 includes a marker 132, and vibrating elements 133R and 133L.

The marker 132 includes a plurality of spheres to reflect infrared light radiated from the position measuring apparatus 140 towards various directions. The marker 132 is used by the position measuring apparatus 140 to detect the position of the operation terminal device 130.

The vibrating elements 133R and 133L are respectively provided to generate vibrations at a right side area and a left side area of the operation terminal device 130. Further, the vibrating elements 133R and 133L are driven according to a vibration pattern corresponding to a tactile sensation associated with the article 111 or 112 represented by a driving signal generated by the drive controlling section 125. The vibrating elements 133R and 133L are an example of a dynamic element.

Note that details of the operation terminal device 130 will be described later below.

The position measuring apparatus 140 includes infrared cameras 140A and 140B that are respectively coupled to the position detecting section 121 through the cables 141A and 141B. The infrared cameras 140A and 140B emit infrared rays to the operation terminal device 130, to shoot the infrared rays reflected by the marker 132. The position measuring apparatus 140 transfers, to the position detecting section 121, image data output by the infrared cameras 140A and 140B. The position measuring apparatus 140 is an example of a first detecting section.

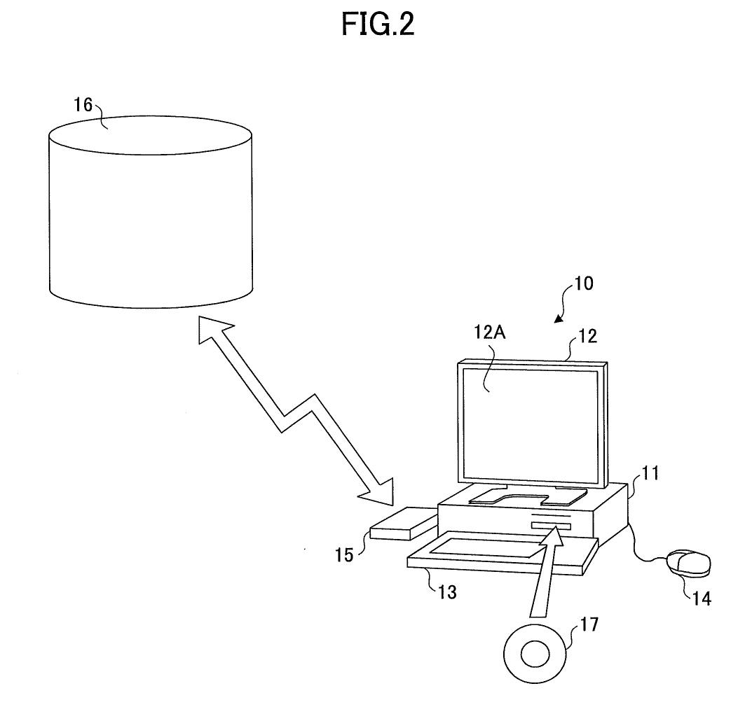

FIG. 2 is a perspective view of a computer system 10 to which the processing apparatus 120 of the first embodiment is applied. The computer system 10 illustrated in FIG. 2 includes a main unit 11, a display 12, a keyboard 13, a mouse 14, and a modem 15.

The main unit 11 includes a Central Processing Unit (CPU), a Hard Disk Drive (HDD), a disk drive, and the like. The display 12 displays an analyzed result or the like on a screen 12A based on an instruction from the main unit 11. The display 12 may be a liquid crystal monitor, for example. The keyboard 13 is an input part for entering various types of information to the computer system 10. The mouse 14 is an input part for designating a suitable position on the screen 12A of the display 12. The modem 15 accesses an external database or the like to download a program or the like stored in other computer system.

A program for causing the computer system to function as the processing apparatus 120 is stored in a removable storage medium such as a disk 17, which is loaded into the computer system 10 and compiled in the computer system 10. Alternatively, the program may be stored in a storage device (or media) 16 in other computer system(s), and is downloaded into the computer system 10 via the modem 15 and the like.

A program for causing the computer system 10 to function as the processing apparatus 120 causes the computer system 10 to operate as the processing apparatus 120. The program may be stored in a computer readable storage medium such as the disk 17. The computer readable storage medium is not limited to a removable storage medium such as the disk 17, an IC card memory, a magnetic disk such as floppy disk (registered trademark), a magneto optical disk, a CD-ROM, a USB (Universal Serial Bus) memory. The computer readable storage medium may include various types of storage media which are accessible in the computer system coupled to the computer system 10 via a communication device such as the modem 15 or LAN.

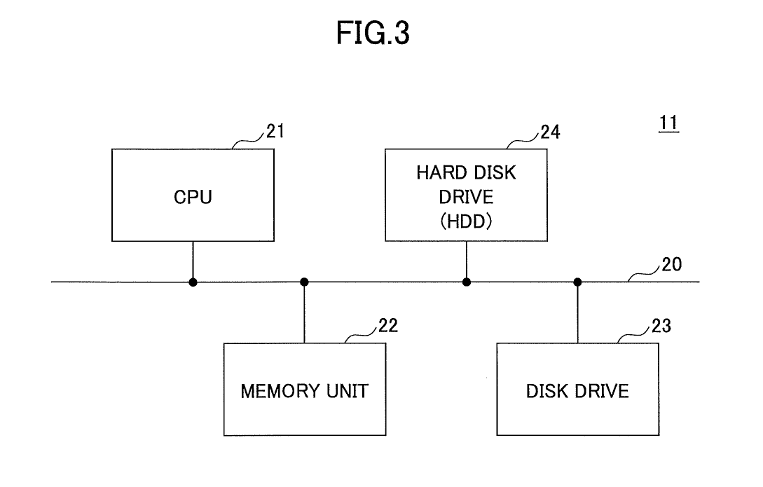

FIG. 3 is a block diagram describing a configuration of major parts in the main unit 11 of the computer system 10. The main unit 11 includes a CPU 21, a memory unit 22 including RAM or ROM, a disk drive 23 for accessing the disk 17, and a hard disk drive (HDD) 24, which are connected to each other via a bus 20. In the present embodiment, the display 12, the keyboard 13, and the mouse 14 are connected to the CPU 21 via the bus 20, but may be directly connected to the CPU 21. Also the display 12 may be connected to the CPU 21 via a well-known graphic interface controller (not illustrated in the drawings) for processing input/output image data.

In the computer system 10, the keyboard 13 and the mouse 14 are the input part of the processing apparatus 120. The display 12 is the display section for displaying contents entered in the processing apparatus 120 on the screen 12A.

Note that the configuration of the computer system 10 is not limited to the configuration illustrated in FIG. 2 or FIG. 3, various well-known components may be added to the computer system 10, or various well-known components may be used alternatively.

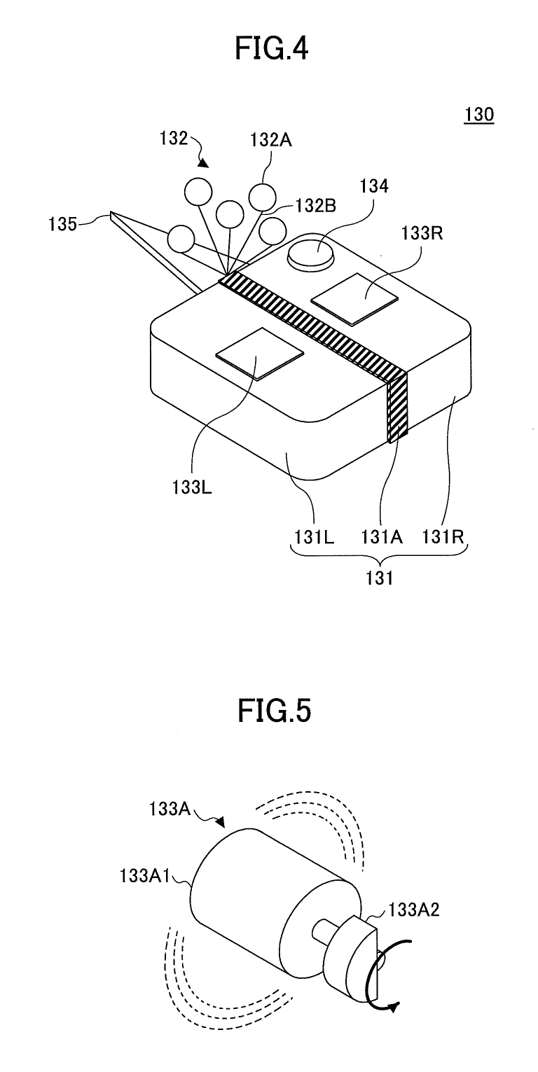

FIG. 4 is a perspective view illustrating the operation terminal device 130.

The operation terminal device 130 includes a housing 131, the marker 132, the vibrating elements 133R and 133L, a button 134, and a guide bar 135.

The user holds the operation terminal device 130 in his/her hand such that the guide bar 135, which is a guideline of the position of the pointer 130A, faces the screen 110A. Hence, the vibrating element 133R is placed on the right side of the user facing the screen 110A, and the vibrating element 133L is placed on the left side.

In the following description, the right and left direction is expressed based on the viewpoint of the user facing the screen 110A with the operation terminal device 130 held such that the guide bar 135 faces the screen 110A.

Further, a surface on which the vibrating elements 133R and 133L are provided is referred to as an upper surface of the housing 131, and a side to which the guide bar 135 is attached is referred to as a front side.

The housing 131 includes housing parts 131R and 131L and an isolating member 131A. The vibrating elements 133R and 133L are respectively disposed on the housing parts 131R and 131L. The housing parts 131R and 131L are examples of base units on which the vibrating elements 133R and 133L are respectively disposed.

Further, the housing parts 131R and 131L are fixed on the isolating member 131A such that vibration occurring in each of the housing parts 131R and 131L is not propagated to each other.

That is, the housing parts 131R and 131L are separate components, and are connected via the isolating member 131A to each other.

For example, the housing parts 131R and 131L are made of resin and have a size suitable for the user holding in his/her hand. The isolating member 131A is a vibration-proof rubber member, for example. A vibration-proof rubber having high damping ratio may be used for the isolating member 131A.

The isolating member 131A is arranged between the housing parts 131R and 131L so as not to propagate the vibration occurring in the housing part 131R by the vibrating element 133R to the housing part 131L and not to propagate the vibration occurring in the housing part 131L by the vibrating element 133L to the housing part 131R.

The marker 132 includes a plurality of spheres 132A and wires 132B. Each of the spheres 132A is attached to the isolating member 131A through the wire 132B.

Because the marker 132 is used by the position measuring apparatus 140 to detect the position and the orientation of the operation terminal device 130, the marker 132 reflects, in various directions, infrared rays emitted from the position measuring apparatus 140. The infrared rays reflected by the marker 132 are captured by the infrared cameras 140A and 140B, and the position detecting section 121 performs image processing with respect to the infrared rays captured by the infrared cameras 140A and 140B, to detect a position and an orientation of the marker 132. The position and the orientation of the marker 132 represent the position and the orientation of the operation terminal device 130.

The number of the spheres constituting the marker 132 is not limited to a specific number, if the marker 132 can reflect the infrared rays towards various irregular directions. Also the locations of the spheres are not restricted. Further, objects other than the spheres may be used for the marker 132. The method of detecting position is not limited to the method using the infrared rays. Any object can be used for the marker 132 so far as it can detect the position of the operation terminal device 130.

The vibrating elements 133R and 133L are respectively provided on the upper surfaces of the housing parts 131R and 131L. The vibrating elements 133R and 133L are driven according to a vibration pattern corresponding to a tactile sensation associated with the article 111 or 112 represented by a driving signal generated by the drive controlling section 125.

The vibrating elements 133R and 133L may be elements for generating vibration such as a piezoelectric element or an LRA (Linear Resonant Actuator). Upon driving the vibrating elements 133R and 133L, vibrations are generated on the surfaces of the housing parts 131R and 131L.

A function of the operation terminal device 130 is assigned to the button 134, so that the user can control the function using the button 134. More than one button 134 may be disposed on the housing 131. Examples of the functions assigned to the button 134 are, a function to turn on (or turn off) the wireless communication with the processing apparatus 120, a function to control brightness of the pointer 130A, and the like.

The guide bar 135 is attached to the front side of the isolating member 131A. The guide bar 135 is provided so that the user can easily recognize the location at which the pointer 130A is displayed, which acts as a guideline of the position of the pointer 130A. In the present embodiment, the guide bar 135 is a plate member having a long triangular shape, for example.

A shape of any member may be used as the guide bar 135, as far as it acts as a guideline or a reference point when the user holding the operation terminal device 130 in his/her hand moves the position of the pointer 130A displayed on the screen 110A.

If the user can easily recognize the position of the pointer 130A without the guide bar 135, the operation terminal device 130 does not need to include the guide bar 135.

FIG. 5 is a diagram illustrating a vibration motor 133A. The vibration motor 133A includes a base 133A1 and a rotation part 133A2. A winding coil is provided in the base 133A1. The rotation part 133A2 is an eccentric structured member. When the rotation part 133A2 is rotated, it propagates vibration to the base 133A1. Such a vibration motor 133A may be used instead of the vibrating elements 133R and 133L illustrated in FIG. 4.

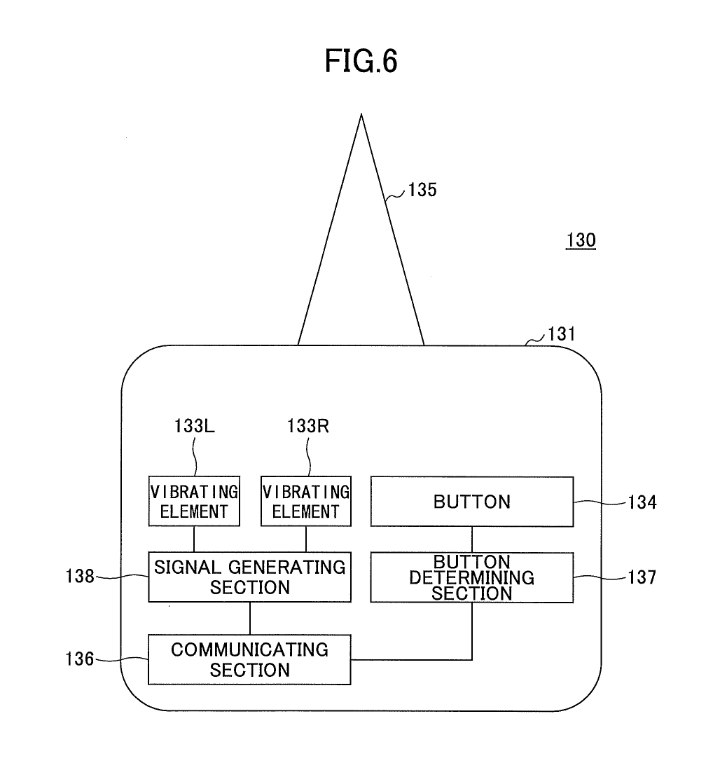

FIG. 6 is a diagram illustrating a configuration of an electrical system in the operation terminal device 130. In FIG. 6, the housing 131 and the guide bar 135 are illustrated in a simplified manner and the marker 132 is omitted.

The operation terminal device 130 includes the vibrating elements 133R and 133L, the button 134, the communicating section 136, a button determining section 137, and a signal generating section 138. The button determining section 137 and the signal generating section 138 are embodied by a processing device such as a microcomputer.

The button determining section 137 and the signal generating section 138 are coupled to the communicating section 136. The communicating section 136 is a communicating section to perform wireless communication with the communicating section 126 in the processing apparatus 120. The communicating section 136 performs, for example, wireless communication in compliance with Bluetooth or Wi-Fi standard.

The communicating section 136 transmits a signal entered from the button determining section 137 to the processing apparatus 120. Further, the communicating section 136 receives a driving signal generated by the drive controlling section 125 of the processing apparatus 120 to output the driving signal to the signal generating section 138.

The button determining section 137 is a determining section to determine whether the button 134 is operated or not. For example, the button determining section 137 determines whether the operation to turn on (or off) the wireless communication with the processing apparatus 120 is performed or not, or whether the operation to control the brightness of the pointer 130A is performed or not. The button determining section 137 outputs a signal representing contents of the operation to the communicating section 136.

The signal generating section 138 amplifies a driving signal received by the communicating section 136 to drive the vibrating element 133R or 133L. Note that the signal generating section 138 may be regarded as a part of the drive controlling section.

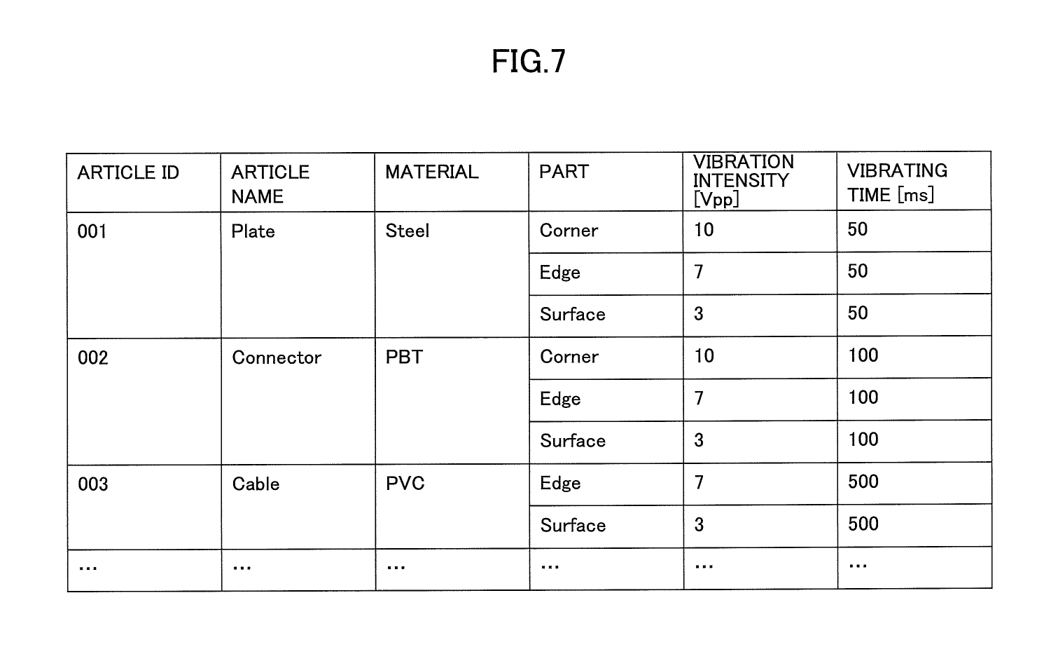

FIG. 7 is a diagram illustrating the vibration data.

The vibration data represents a vibration pattern corresponding to a tactile sensation associated with an article displayed on the screen 110A. The vibration data includes, for example, an article ID, an article name, a material, a part name, vibration intensity, and a vibrating time.

The article ID is an identifier assigned to each article. All articles have article IDs that are different from each other. FIG. 7 illustrates, as examples of the article IDs, 001, 002, and 003.

The article name is a name of an article. FIG. 7 illustrates, as examples of the article names, Plate, Connector, and Cable.

The material included in the vibration data represents a material of surfaces of an article. FIG. 7 illustrates, as examples of the materials, Steel, PBT (polybutylene terephthalate), and PVC (polyvinyl chloride).

The part name represents parts included in an article. In FIG. 7, as examples of the parts, “Corner”, “Edge”, and “Surface” are illustrated. If an article is a cuboid shape object, “Corner” means corners located at 8 apexes of a cuboid. “Edge” means 12 edges of a cuboid. Also, “Surface” means 6 planes of a cuboid. If an article is a spherical object, it does not have the part names of “Corner” and “Edge”, it only has “Surface” as the part name. The part name is assigned not only to a cuboid shape article or a spherical article, but also to articles having various shapes.

The vibration intensity represents amplitude (Vpp) of a driving signal for driving the vibrating element 133R or 133L. In FIG. 7, the vibration intensity is represented as peak-to-peak voltage. In FIG. 7, the vibration intensity is defined so that “Corner” has the strongest intensity, “Surface” has the weakest intensity, and the “Edge” has moderate intensity.

This is because of the following reason. Among a corner, an edge, and a surface of an object, the user feels the strongest tactile sensation when the user touches the corner, and the user feels the weakest tactile sensation when the user touches the surface. Further, the strength of the tactile sensation when the user touches the edge is moderate (between the corner and the surface). In the present embodiment, for example, the vibration intensity associated with every material is defined in the same manner described here.

The vibrating time represents duration of time (ms) for driving the vibrating element 133R or 133L. For example, the vibrating times are set such that the length of the vibrating time is different depending on the materials (steel, PBT, PVC) of the article. The article made of steel has the shortest vibrating time, the article made of PVC has the longest vibrating time, and the article made of PBT has moderate vibrating time (between steel and PVC). The reason why the vibrating time of each material is set as described here will be described in the following.

Among the three materials mentioned above, since steel has the largest Young's modulus, vibration occurring in steel subsides in a short time. Also, since PVC has the smallest Young's modulus among the three materials, it takes the longest time until vibration subsides. Further, a Young's modulus of PBT is between steel and PVC.

As described above, in the vibration data, the vibration intensity and the vibrating time are defined for each part, to produce the tactile sensation that the user perceives when he/she actually touches the surface of the article with his/her hand in a real space, by the vibration generated in the vibrating elements 133R and 133L.

Note that the vibration data is stored in the data storage section 124 of the processing apparatus 120.

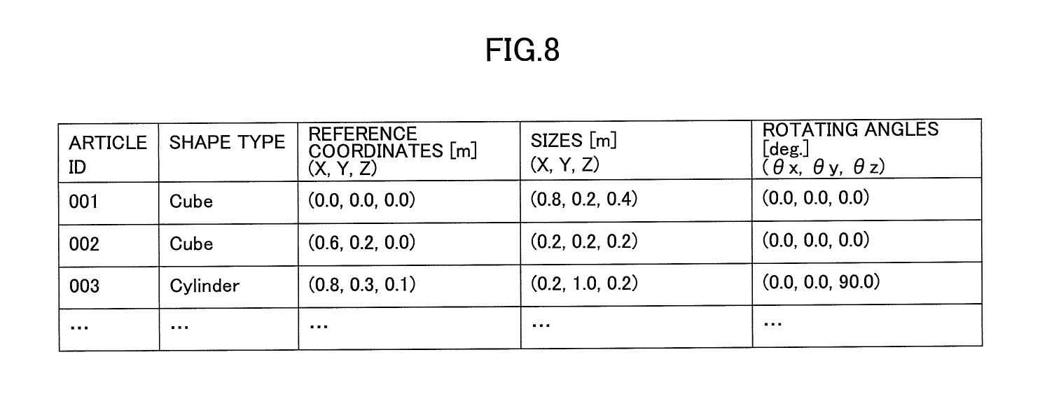

FIG. 8 is a diagram illustrating article data.

The article data includes data representing the coordinates and the shape of the article which is displayed on the screen 110A. The article data includes an article ID, a shape type, reference coordinates, sizes, and rotating angles.

The shape type represents an exterior shape of the article. FIG. 8, as an example, illustrates a case where information of articles whose shape types are “Cube” (cuboid) and an article whose shape type is “Cylinder” are stored.

The reference coordinates represent the coordinates of a point of reference of an article out of each point of the article. The coordinate values are in units of meters (m). Note that an XYZ coordinate system (three dimensional Cartesian coordinate system) is used as the coordinate system.

The sizes include three values, each of which represents a length in an X-axis direction, a length in a Y-axis direction, and a length in a Z-axis direction of the article. The values are in units of meters (m). For example, the length in an X-axis direction represents a longitudinal length; the length in a Y-axis direction represents a height; and the length in a Z-axis direction represents a depth (lateral length).

The rotating angles include three values, each of which represents X-axis rotation angle θx, Y-axis rotation angle θy, and Z-axis rotation angle θz. The values are in units of degrees (deg.). The rotation angle ex is the value representing by what degree the article is rotated around the X-axis. Also, the rotation angles θy and θz respectively represent by what degrees the article is rotated around the Y-axis and the Z-axis. The positive direction of the rotation angles ex, θy and θz may be determined in advance.

By using this article data, an image of each article can be expressed, similar to an image of an article represented by CAD data.

Note that the article data is stored in the data storage section 124 of the processing apparatus 120.

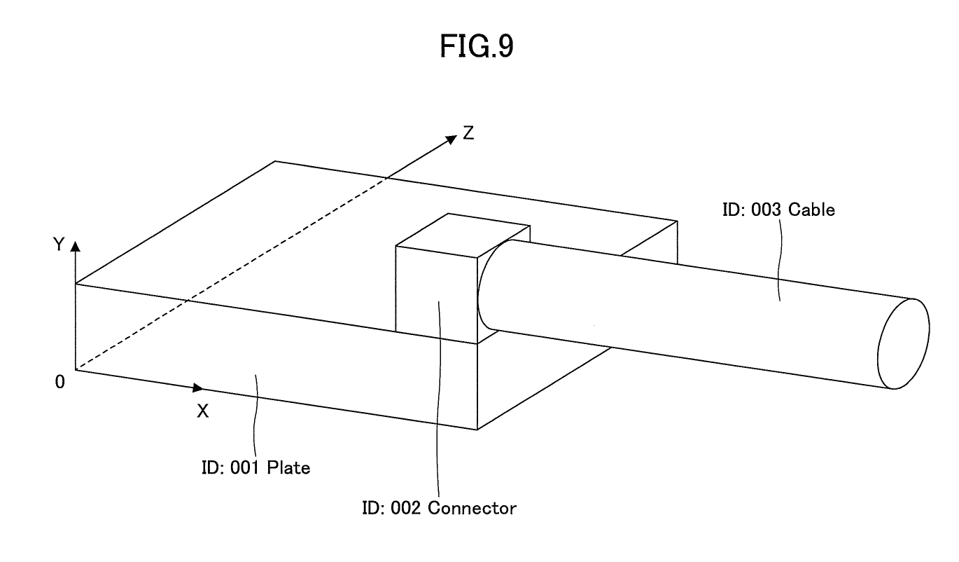

FIG. 9 illustrates an example of images of articles.

In FIG. 9, three articles which are expressed based on the article data in FIG. 8 are illustrated.

An article whose article ID is 001 is the article whose shape type is “Cube” (cuboid), whose reference coordinates (X, Y, Z) are (0.0, 0.0, 0.0), whose size is (0.8, 0.2, 0.4), and whose rotating angles θx, θy and θz are (0.0, 0.0, 0.0).

Since the reference coordinates (X, Y, Z) are (0.0, 0.0, 0.0), one of the apexes of the article whose article ID is 001 coincides with the origin (O) of the XYZ coordinates system.

An article whose article ID is 002 is the article whose shape type is “Cube” (cuboid), whose reference coordinates (X, Y, Z) are (0.6, 0.2, 0.0), whose size is (0.2, 0.2, 0.2), and whose rotating angles θx, θy and θz are (0.0, 0.0, 0.0).

Therefore, the article whose article ID is 002 is placed on the article whose article ID is 001.

An article whose article ID is 003 is the article whose shape type is “Cylinder”, whose reference coordinates (X, Y, Z) are (0.8, 0.3, 0.1), whose size is (0.2, 1.0, 0.2), and whose rotating angles θx, θy and θz are (0.0, 0.0, 90.0).

Therefore, the article whose article ID is 003 is rotated by 90 degrees around the Z-axis, and is in contact with the article having article ID 002. Among the surfaces of the article having article ID 002, one of the surfaces which is perpendicular to the X-axis and which is the farther from the origin is in contact with the article having article ID 003.

In the present embodiment, as described above, the coordinates and the shape of the article in an image displayed on the screen 110A is determined by using the article data illustrated in

FIG. 8 which includes the article ID, the shape type, the reference coordinates, the sizes, and the rotating angles.

For example, in a case where the shape type of an article is “Cube” (cuboid), the coordinates of the eight apexes of the article can be derived by adding or subtracting the length in an X-axis direction, the length in a Y-axis direction, or the length in a Z-axis direction contained in the sizes of the article data, to/from the reference coordinates. The coordinates of the eight apexes represent the coordinates of the corners of the article whose article type is “Cube”.

If the coordinates of the eight apexes are obtained, formulas for expressing the twelve edges of the article (cuboid) can be obtained. The formulas for expressing the twelve edges represent the coordinates of the edges of the article whose shape type is “Cube” (cuboid).

Further, by obtaining the coordinates of the eight apexes and/or the formulas for expressing the twelve edges, formulas for expressing the six surfaces of the article whose shape type is “Cube” (cuboid) can be obtained. In other words, the coordinates of the surfaces of the article can be obtained.

In a case where the shape type of an article is “Cylinder”, based on the length in an X-axis direction, the length in a Y-axis direction, and the length in a Z-axis direction contained in the sizes of the article data, formulas for expressing circles (or ellipses) at both ends of the cylinder can be obtained. Also, by using the formulas expressing the circles (or ellipses) at both ends of the cylinder and the reference coordinates, formulas expressing the coordinates on the circles (or ellipses) at both ends of the cylinder can be obtained. The coordinates of side surface of the cylinder can be obtained using the formulas expressing the coordinates on the circles (or ellipses) at both ends of the cylinder.

Here, a method of obtaining the coordinates and the shape of an image of the article displayed on the screen 110A is described, especially when the shape type of the article is “Cube” or “Cylinder”. However, with respect to the articles having various shapes, such as sphere, triangular pyramid, or concave polyhedron, the coordinates and the shape of the article in the image projected on the screen 110A can be obtained.

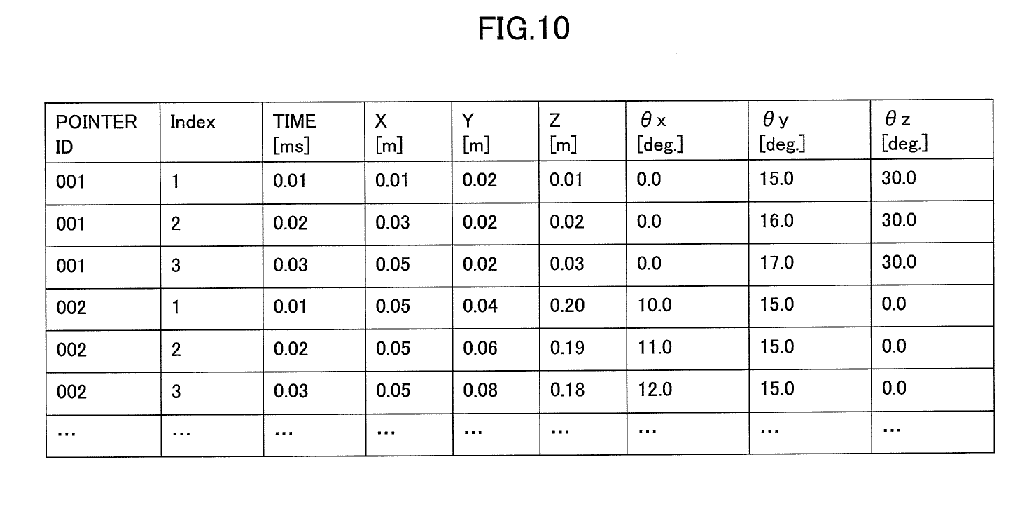

FIG. 10 is a table illustrating a time variation of the coordinates of the pointer 130A in the image projected on the screen 110A.

Before starting to use the simulation system 100, calibration of the operation terminal device 130 is performed. The calibration is a process for correlating the initial position of the operation terminal device 130 detected by the position detecting section 121 with the location of the pointer 130A in the images (virtual space) displayed on the screen 110A. The location of the pointer 130A is expressed as the coordinates in the XYZ coordinate system which are used for expressing the article data of the article.

By performing the calibration of the operation terminal device 130 before using the simulation system 100, the initial location of the pointer 130A in the image displayed on the screen 110A is determined.

The table in FIG. 10 includes a pointer ID, an index, time, X coordinate, Y coordinate, Z coordinate, and rotating angles θx, θy and θz. The units of each parameter are also illustrated in FIG. 10.

The pointer ID is an identifier assigned with each operation terminal device 130. The index represents the number of times acquiring coordinate data of the operation terminal device 130 identified with the pointer ID. Since the number of times acquiring coordinate data is counted for each of the operation terminal devices 130, each pointer ID (each operation terminal device 130) is assigned with an independent index. The time represents elapsed time from start of measurement. Note that the coordinate data of the operation terminal device 130 mentioned here represents the coordinates of the pointer 130A.

Every time a unit of time passes, the processing apparatus 120 detects the coordinates of the operation terminal device 130, and converts the detected coordinates into the coordinate data of the pointer 130A as illustrated in FIG. 10, to create data representing the time variation of the coordinates of the pointer 130A.

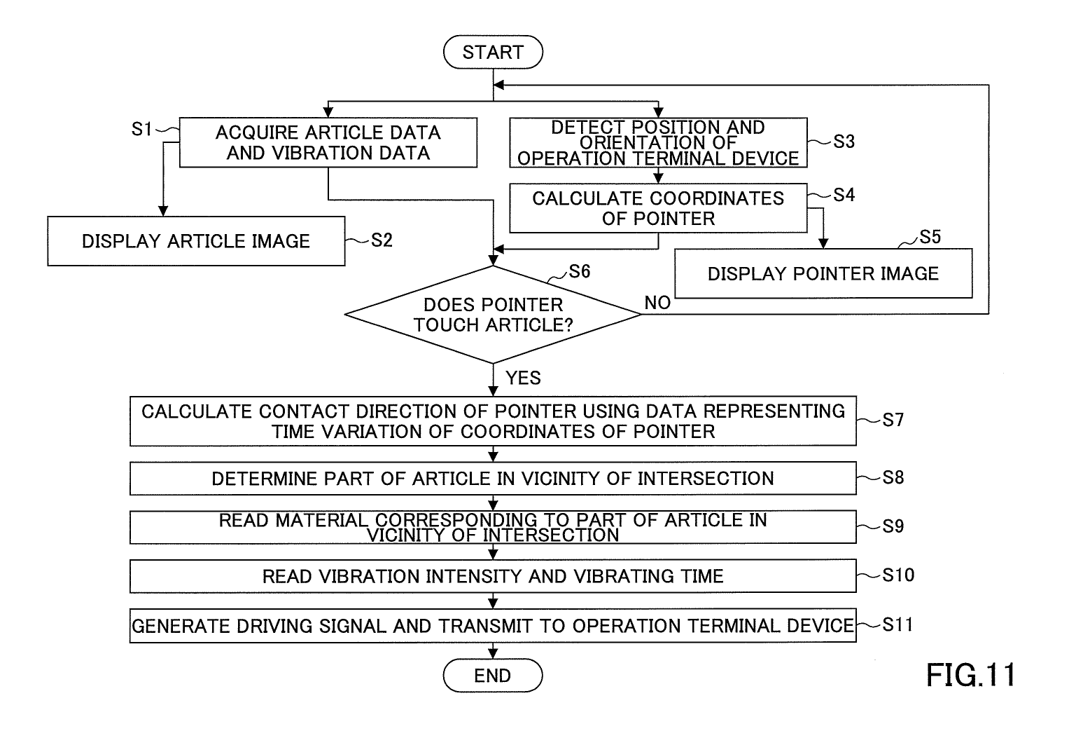

FIG. 11 is a flowchart describing the process performed in the processing apparatus 120 according to the first embodiment. As an example, the case where articles 111 and 112 are displayed on the screen 110A will be described, as illustrated in FIG. 1.

The processing apparatus 120 starts processing after power-on (start).

The processing apparatus 120 acquires the article data and the vibration data from the data storage section 124 (step S1).

The processing apparatus 120 generates image signals using the article data, to cause the projecting apparatus 110B to project an image (step S2). By performing the step S2, stereoscopic images of the articles 111 and 112 are displayed on the screen 110A. The images of the articles 111 and 112 displayed on the screen 110A represent virtual objects which exist in the virtual space.

Note that the processes of steps S1 and S2 are performed by the image output section 123.

The processing apparatus 120 detects a position and an orientation of the operation terminal device 130 in an actual space. The process of step S3 is performed by the position detecting section 121.

The processing apparatus 120 calculates the coordinates of the pointer 130A in the virtual space (step S4). The coordinates of the pointer 130A are calculated by the position detecting section 121. The coordinate data of the pointer 130A is entered into the contact determining section 122 and the image output section 123.

The processing apparatus 120 causes the projecting apparatus 110B to display the pointer 130A on the screen 110A, based on the coordinates of the pointer 130A obtained at step S4 (step S5). The pointer 130A is displayed, for example, such that the pointer 130A coincides with a tip of the guide bar 135 when the user of the operation terminal device 130 sees the pointer 130A.

By performing the step S5, the pointer 130A is displayed on the screen 110A where the stereoscopic images of the articles 111 and 112 are displayed.

Also at step S5, the processing apparatus 120 may display the pointer 130A using an image data representing the pointer 130A. With respect to the data representing the pointer 130A, data suitable to the article data of the article 111 or 112 may be prepared in advance. When the data is prepared in advance, the processing apparatus 120 may display the stereoscopic images of the pointer 130A using the data. However, if the processing apparatus 120 can display the pointer 130A without using image data of the pointer, it is not required that image data of the pointer 130A be stored in the data storage section 124.

The process of step S5 is performed by the image output section 123. Note that the steps S3 to S5 are executed in parallel with the steps S1 and S2.

The processing apparatus 120 determines whether the pointer 130A has touched the article 111 or 112 (step S6). The step S6 is performed by the contact determining section 122. Based on the article data of the articles 111 and 112, and the coordinate data of the pointer 130A obtained at step S4, the contact determining section 122 determines whether the pointer 130A touches the article 111 or 112.

Whether the article 111 or 112 is touched by the pointer 130A or not may be determined by checking if there is an intersection point between the location represented by the coordinate data of the pointer 130A and the corners, the edges, or the surfaces of the article represented by the article data for the article 111 or 112.

Alternatively, whether the article 111 or 112 is touched by the pointer 130A or not may be determined by checking if distance between the coordinates of the pointer 130A and the coordinates included in the article that is closest to the pointer 130A is not more than a given value. If the method of checking the distance between the coordinates of the pointer 130A and the coordinates included in the article that is closest to the pointer 130A makes the operability of the operation terminal device 130 in the simulation system 100 better than the method mentioned earlier, the method of checking the distance between the coordinates of the pointer 130A and the coordinates included in the article that is closest to the pointer 130A may be adopted.

Next, the process performed at step S7 will be described. In describing the process at step S7, it is assumed that the pointer 130A has touched the article 111. However, when the pointer 130A has touched the article 112, a similar process is performed.

When the processing apparatus 120 determines that the pointer 130A has touched the article 111 (S6: YES), the processing apparatus 120 calculates the direction of contact of the pointer 130A with the article 111 (from which direction the pointer 130A has come in contact with the article 111), based on the data representing the time variation of the coordinates of the pointer 130A (FIG. 10) (step S7).

The direction of contact may be calculated based on the location of the pointer 130A with respect to the article 111 at the time just before the pointer 130A has touched the article 111, which is included in the data representing the time variation of the coordinates of the pointer 130A. The process of step S7 is performed by the contact determining section 122.

The processing apparatus 120 determines the part of the article 111 in the vicinity of the intersection point between the article 111 and the pointer 130A (step S8).

The vicinity described here may be, for example, a three-dimensional region within a distance of 1 cm from the intersection point, if the article 111 is a cube having edges of 1 m.

Additionally, when determining a part of the article, the processing apparatus 120 may determine whether the surface, the edge, or the corner exists in the vicinity, and if multiple types of parts of the article exist in the vicinity, the determination may be made in accordance with the order of precedence (corner, edge, and surface). That is, when the surface, the edge, and the corner exist in the vicinity, the part of the article in the vicinity may be determined as the corner.

When the surface and the edge exist in the vicinity, the part of the article in the vicinity may be determined as the edge. Further, when the surface and the corner exist in the vicinity, the part of the article in the vicinity may be determined as the corner. Also when one of the surface, the edge, and the corner exists in the vicinity, whichever part is in the vicinity may be determined as the part of the article which exists in the vicinity.

The processing apparatus 120 reads, from the vibration data (FIG. 7), the material of the part in the vicinity of the intersection point by using the article ID of the article 111 touched by the pointer 130A and the part determined at step S8 (step S9).

For example, when the article ID is 001 and the part is corner, the material may be determined as “Steel”. Though the vibration data illustrated in FIG. 7 represents that all different parts belonging to the same article (same article ID) are made of the same material, vibration data representing different parts belonging to the same article that are made of different materials may be used.

The processing apparatus 120 reads, from the vibration data, the vibration intensity and the vibrating time corresponding to the part of the article 111 touched by the pointer 130A, by using the article ID of the article 111 touched by the pointer 130A and the part determined at step S8 (step S10).

The processing apparatus 120 generates a driving signal for driving the vibrating element 133R or 133L of the operation terminal device 130, and transmits the signal to the operation terminal device 130 via the communicating section 126 (step S11). As a result, the vibrating element 133R or 133L of the operation terminal device 130 is driven.

The driving signal is generated based on the direction of contact calculated at step S7 and the vibration intensity and the vibrating time identified at step S10. The steps S8 to S11 are performed by the drive controlling section 125.

The sequence of the process is terminated (end).

If it is determined at step S6 that the pointer 130A has not touched the article 111 or 112 (S6: NO), the process reverts to steps S1 and S3.

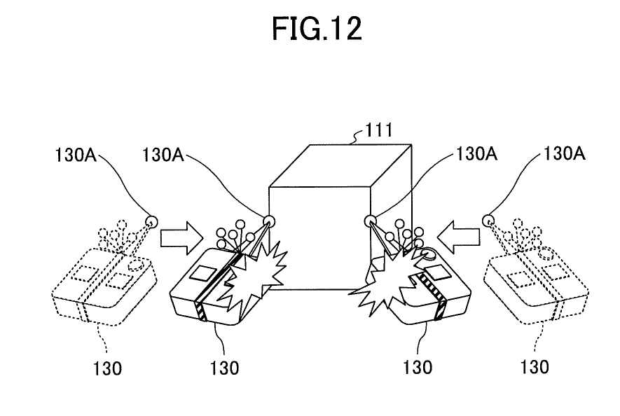

Next, how to drive the vibrating element 133R or 133L when the pointer 130A touches the article 111 will be described with reference to FIG. 12.

FIG. 12 is a diagram illustrating the method of providing the tactile sensation when the pointer 130A touches the article 111.

When expressing that the pointer 130A approaches the article 111 from the right and the left side of the pointer touches the article 111, the vibrating element 133L disposed on the left side of the operation terminal device 130 is driven.

The reason is to make the user recognize with the tactile sensation that the left side of the pointer 130A touches the article 111, by making the vibrating element 133L of the operation terminal device 130 generate vibration.

When expressing that the pointer 130A approaches the article 111 from the left and the right side of the pointer 130A touches the article 111, the vibrating element 133R disposed on the right side of the operation terminal device 130 is driven.

This is to make the user recognize with the tactile sensation that the right side of the pointer 130A touches the article 111, by making the vibrating element 133R of the operation terminal device 130 generate vibration.

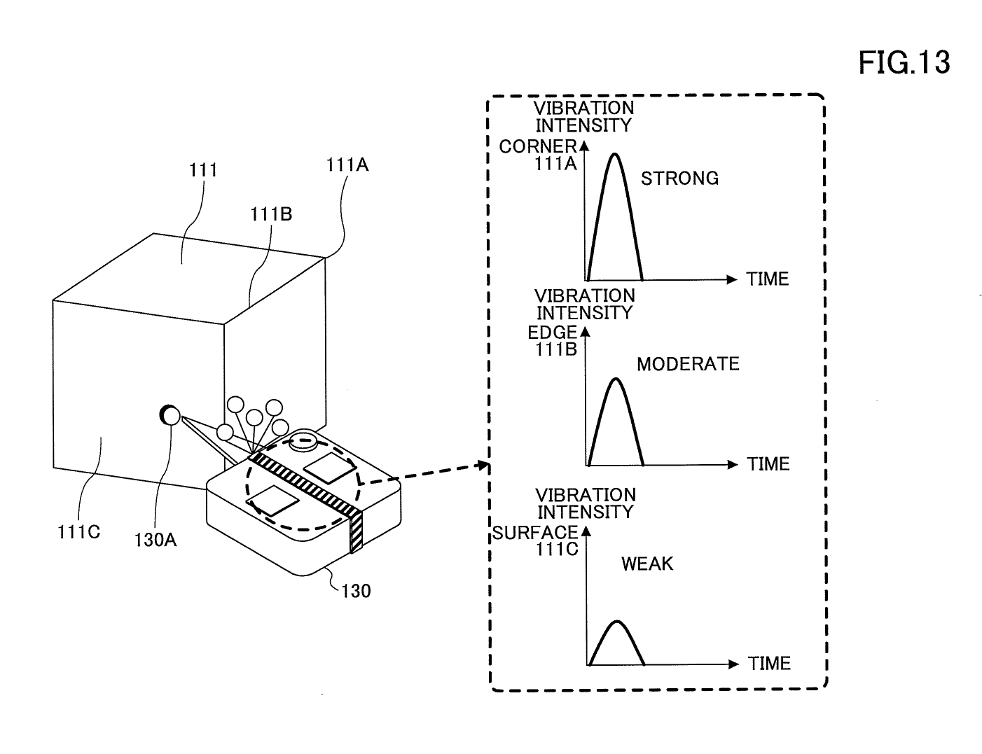

Next, with reference to FIGS. 13 to 16, the degree of the vibration intensity and the length of the vibrating time for driving the vibrating element 133R or 133L will be described. Here, the case where the pointer 130A touches the article 111 will be described, unless otherwise stated. The article 111 is simply an example of the articles that the simulation system 100 displays on the screen 110A. Therefore, the following description can also be applied to the case where the pointer 130A touches articles other than the article 111.

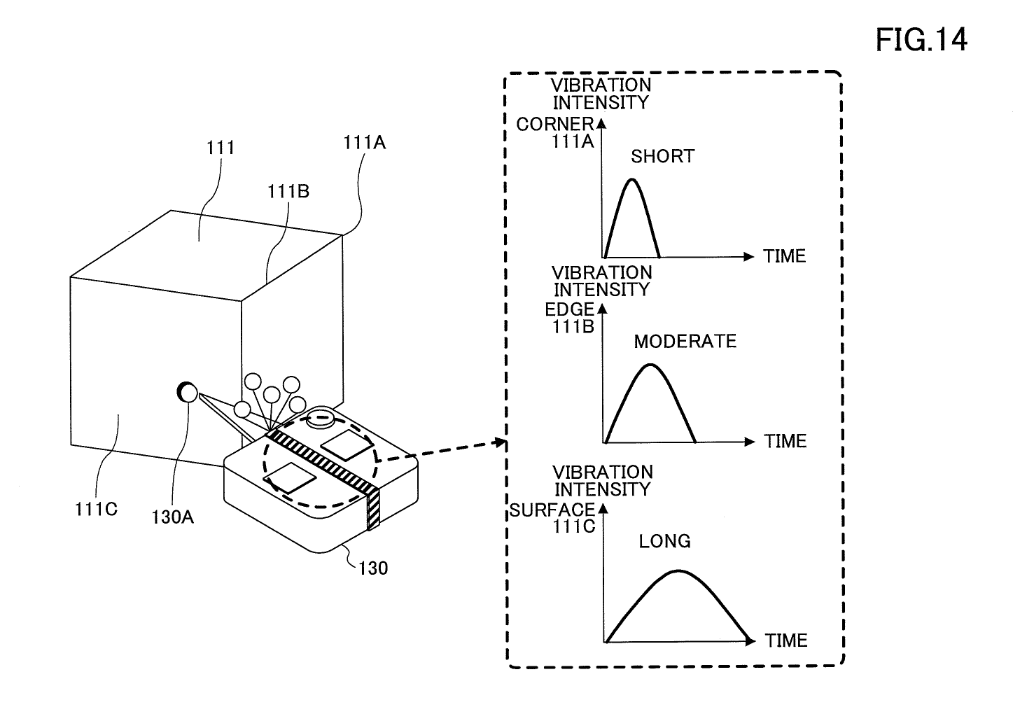

FIGS. 13 and 14 are drawings illustrating the relation between the part of the article 111 that the pointer 130A touches and the vibration pattern.

As illustrated in FIG. 13, the article 111 includes a corner 111A, an edge 111B, and a surface 111C. The corner 111A, the edge 111B, and the surface 111C correspond to “Corner”, “Edge”, and “Surface” defined in the vibration pattern respectively.

When the pointer 130A touches the corner 111A, the simulation system 100 makes the vibration intensity (amplitude) stronger (larger). When the pointer 130A touches the edge 111B, the simulation system 100 sets the vibration intensity (amplitude) moderately. And, when the pointer 130A touches the surface 111C, the simulation system 100 makes the vibration intensity (amplitude) weaker (smaller). The length of time to generate vibration is constant regardless of the degree of the vibration intensity.

As described above, the simulation system 100 changes the vibration intensity depending on which part of the article 111 the pointer 130A touches among the corner 111A, the edge 111B, and the surface 111C. Since the corner 111A has a small contact area and gives a tactile feeling like a needle to one who actually touches the corner 111A with his/her hand, the strongest vibration intensity is given when the pointer 130A touches the corner 111A. Conversely, since the surface 111C has a large contact area and gives a smooth tactile feeling to one who actually touches the corner 111A, the weakest vibration intensity is given when the pointer 130A touches the surface 111C. Moreover, since the edge 111B has a moderate contact area size (between the corner 111A and the surface 111C), moderate vibration intensity is given when the pointer 130A touches the edge 111B.

As described above, by changing the vibration intensity in accordance with the part where the pointer 130A touches, for example, the simulation system 100 can provide the tactile sensation to the user who operates the pointer 130A of the operation terminal device 130 according to the part of the article 111 touched by the pointer 130A.

In FIG. 14, an example for changing the length of time to generate the vibration is illustrated, instead of changing the vibration intensity.

When the pointer 130A touches the corner 111A, the simulation system 100 shortens the vibrating time. When the pointer 130A touches the edge 111B, the simulation system 100 sets the vibrating time moderately. And, when the pointer 130A touches the surface 111C, the simulation system 100 lengthens the vibrating time. The vibration intensity is constant regardless of the length of the vibrating time.

As described above, the simulation system 100 changes the vibrating time depending on which part of the article 111 the pointer 130A touches among the corner 111A, the edge 111B, and the surface 111C. Since the corner 111A has a small contact area and gives a tactile feeling like a needle to one who actually touches the corner 111A with his/her hand, the shortest vibrating time is given when the pointer 130A touches the corner 111A. Conversely, since the surface 111C has a large contact area and gives a smooth tactile feeling to one who actually touches the corner 111A, the longest vibrating time is given when the pointer 130A touches the surface 111C. Moreover, since the edge 111B has a moderate contact area size (between the corner 111A and the surface 111C), a moderate length of vibrating time is given when the pointer 130A touches the edge 111B.

By changing the vibrating time in accordance with the part where the pointer 130A touches as described above, the simulation system 100 can provide the tactile sensation to the user who operates the pointer 130A of the operation terminal device 130 according to the part of the article 111 touched by the pointer 130A.

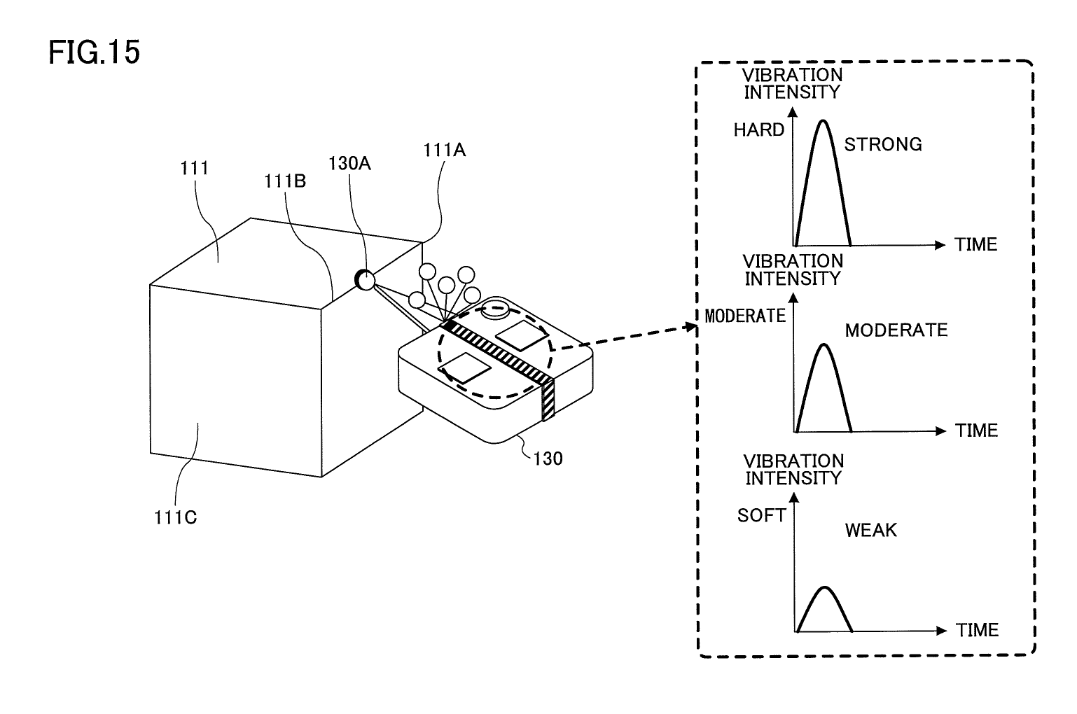

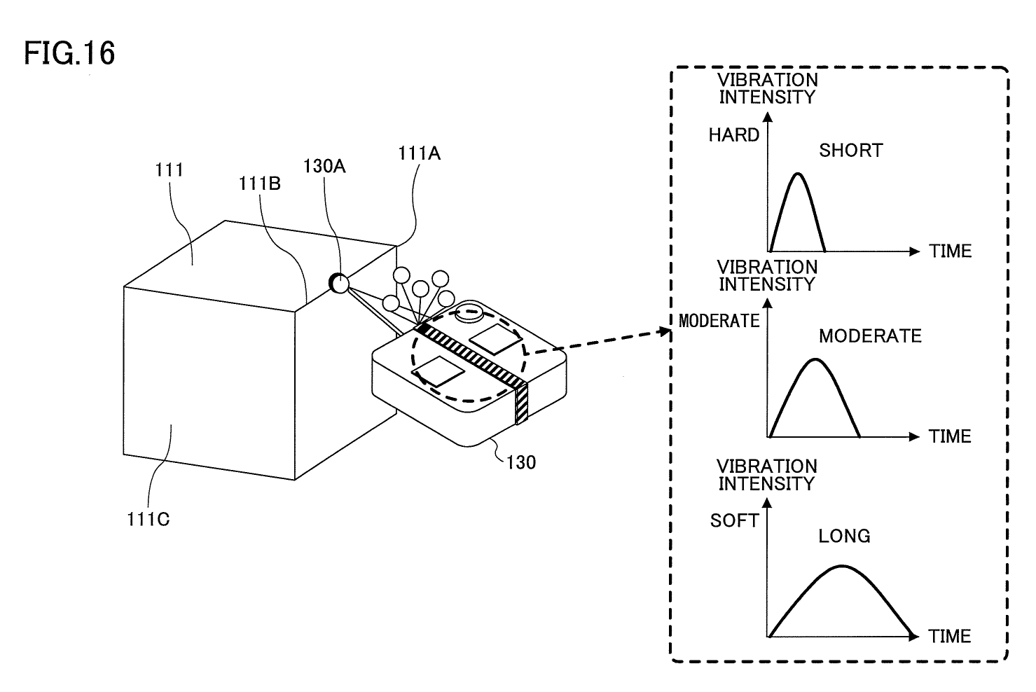

FIGS. 15 and 16 are drawings illustrating the relation between the material of the article 111 touched by the pointer 130A and the vibration pattern.

FIG. 15 illustrates an example for changing the vibration intensity depending on the material of the article such as the article 111 or 112.

The vibration data depending on the Young's modulus is prepared in advance. For example, three types of vibration data, such as the vibration data for a hard material, the vibration data for a soft material, and the vibration data for a material having moderate hardness, are prepared. In the following description for example, the following definitions are used. The material having a Young's modulus not less than 10 GPa is a hard material, the material having a Young's modulus between 1 GPa and GPa is a material having moderate hardness (a moderate material), and the material having a Young's modulus not more than 1 GPa is a soft material.

When the material of the article touched by the pointer 130A is hard, the simulation system 100 makes the vibration intensity (amplitude) stronger (larger). When the material of the article touched by the pointer 130A has moderate hardness, the simulation system 100 sets the vibration intensity (amplitude) moderately. And, when the material of the article touched by the pointer 130A is soft, the simulation system 100 makes the vibration intensity (amplitude) weaker (smaller). The length of time to generate vibration is constant regardless of the degree of the vibration intensity.

By changing the vibration intensity in accordance with the material touched by the pointer 130A as described above, the simulation system 100 can provide the tactile sensation to the user who operates the pointer 130A of the operation terminal device 130 according to the material of the article touched by the pointer 130A.

FIG. 16 illustrates an example for changing the vibrating time depending on the material of the article such as the article 111 or 112.

As mentioned in the description of FIG. 15, the vibration data depending on the Young's modulus is prepared in advance. In the following description for example, the following definitions are used. A material having a Young's modulus not less than 10 GPa is a hard material, a material having a Young's modulus between 1 GPa and 10 GPa is a moderate material, and a material having a Young's modulus not more than 1 GPa is a soft material.

When the material of the article touched by the pointer 130A is hard, the simulation system 100 shortens the vibrating time. When the material of the article touched by the pointer 130A has moderate hardness, the simulation system 100 sets the vibrating time moderately. Further, when the material of the article touched by the pointer 130A is soft, the simulation system 100 makes the vibrating time longer. The vibration intensity is constant regardless of the length of the vibrating time.

By changing the vibrating time in accordance with the material touched by the pointer 130A as described above, the simulation system 100 can provide the tactile sensation to the user who operates the pointer 130A of the operation terminal device 130 according to the material of the article touched by the pointer 130A.

A combination of the method of changing the vibration intensity in accordance with the part of the article as described in FIG. 13 and the method of changing the vibrating time in accordance with the material of the article as described in FIG. 16 may be used. By using a combination of these methods, the vibration pattern can be changed in accordance with the part and the material of the article.

Further, a combination of the method of changing the vibrating time in accordance with the part of the article as described in FIG. 14 and the method of changing the vibration intensity in accordance with the material of the article as described in FIG. 15 may be used. By using a combination of these methods, the vibration pattern can be changed in accordance with the part and the material of the article.

As described above, in the simulation system 100 according to the first embodiment, when the pointer 130A operated by the operation terminal device 130 has touched an article such as the article 111 or 112 in the image projected on the screen 110A, the simulation system 100 changes the vibration pattern to vibrate the vibrating element 133R or 133L in accordance with the part or material of the article touched by the pointer 130A.

Since the simulation system 100 can provide the tactile sensation to the user according to the part or the material of the article, the user can recognize the difference in the part or the material of the article by the tactile sensation alone. It is preferable that the user is touching the vibrating element 133R or 133L when holding the operation terminal device 130. However, even if the user is not touching the vibrating element 133R or 133L, the housing part 131R or 131L also vibrates in accordance with the part or the material of the article. Therefore, the user can recognize the difference in the part or the material of the article by the tactile sensation alone even if the user is not touching the vibrating element 133R or 133L.

In addition, the simulation system 100 according to the first embodiment vibrates one of the vibrating elements 133R and 133L in accordance with the direction from which the pointer 130A has come in contact with the article.

Therefore, the user can recognize from which direction the pointer 130A has come in contact with the article, by the tactile sensation alone.

As described above, the simulation system 100 according to the present embodiment can provide the user the tactile sensation associated with the article according to the direction from which the user touches the article, in addition to the tactile sensation associated with the article according to the part or the material of the article. These tactile sensations simulatively represent a sensation of the user touching the article with his/her hand in an actual space, with very high reality.

Hence, the first embodiment can provide the simulation system 100 that can provide a realistic tactile sensation.

In the above description, the example is explained such that the position and the orientation of the operation terminal device 130 is detected using the position measuring apparatus 140 (the infrared cameras 140A and 140B) and the marker 132. However, the position and the orientation of the operation terminal device 130 may be detected using at least one of an infrared depth sensor, a magnetometer, a stereo camera, an acceleration sensor, and an angular velocity sensor, which do not require the marker 132.

Further, the vibrating elements 133R and 133L may be driven in accordance with a drive controlling signal to generate natural vibration in an ultrasonic band. In this case, the natural vibration in the ultrasonic band occurs on outer surfaces of the housing parts 131R and 131L.

The ultrasonic band is, for example, a waveband not less than approximately 20 kHz, which is higher than an audio frequency audible by a human being. When the natural vibration in the ultrasonic band occurs on outer surfaces of the housing parts 131R and 131L, a tactile sensation having a ruggedness feeling can be provided by squeeze film effect.

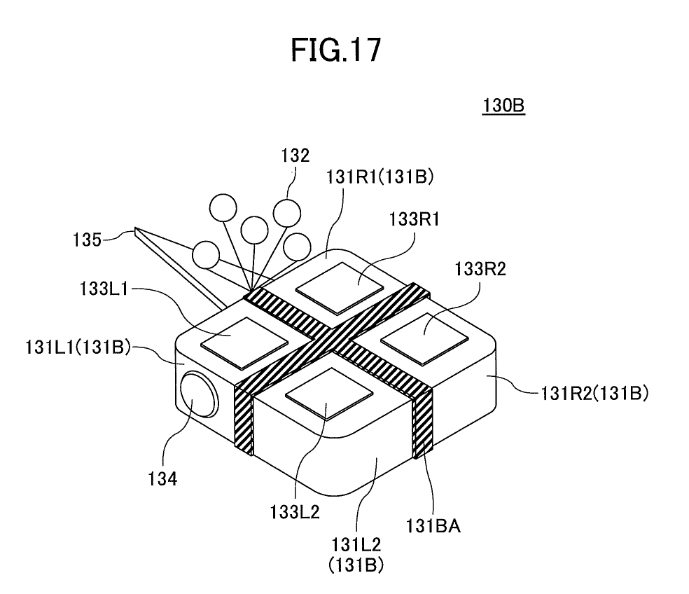

Next, some modified examples of the first embodiment will be described with reference to FIGS. 17 to 22.

FIGS. 17 to 22 are drawings illustrating modified examples of the first embodiment.

An operation terminal device 130B illustrated in FIG. 17 includes four housing parts each containing one of four vibrating elements 133R1, 133R2, 133L1, and 133L2. The shape of the four housing parts is made by splitting the housing 131 of the operation terminal device 130 illustrated in FIG. 4 into four pieces. Other configurations of the operation terminal device 130B are similar to the operation terminal device 130. Therefore in the following description, the same symbol is attached to the same component, and repeated explanation about the same component is omitted.

The operation terminal device 130B includes a housing 131B, a marker 132, vibrating elements 133R1, 133R2, 133L1 and 133L2, a button 134, and a guide bar 135.

The housing 131B includes housing parts 131R1, 131R2, 131L1, and 131L2, and an isolating member 131BA. The vibrating elements 133R1, 133R2, 133L1, and 133L2 are respectively provided in the housing parts 131R1, 131R2, 131L1, and 131L2.

The isolating member 131BA is a wall-like member, which is a cross-shaped member in a planar view and is disposed as if the housing parts 131R1, 131R2, 131L1, and 131L2 were divided by the isolating member 131BA. The housing parts 131R1, 131R2, 131L1, and 131L2 are fixed on the isolating member 131BA such that vibrations occurring in each of the housing parts 131R1, 131R2, 131L1, and 131L2 are not propagated to each other.

That is, the housing parts 131R1, 131R2, 131L1, and 131L2 are separate components, and are connected via the isolating member 131BA to each other.

Shapes of the housing parts 131R1, 131R2, 131L1, and 131L2 are similar to a piece of the housing part 131R or 131L made by dividing the housing part 131R or 131L in half. The housing parts 131R1, 131R2, 131L1, and 131L2 are made of resin, for example. The isolating member 131BA is a vibration-proof rubber member, for example. A vibration-proof rubber having a high damping ratio may be used for the isolating member 131BA.

The vibrating elements 133R1, 133R2, 133L1, and 133L2 are driven according to a vibration pattern corresponding to a tactile sensation associated with the article 111 or 112 represented by a driving signal generated by the drive controlling section 125.

The vibrating elements 133R1, 133R2, 133L1, and 133L2 may be, for example, an element containing a piezoelectric element or an LRA (Linear Resonant

Actuator), similar to the vibrating element 133R or 133L illustrated in FIG. 4. Upon driving the vibrating elements 133R1, 133R2, 133L1, and 133L2 respectively, vibrations are generated on the surfaces of the housing parts 131R1, 131R2, 131L1, and 131L2.

By using the operation terminal device 130B, more types of tactile sensations can be provided in accordance with the part or the material of the article touched by the pointer 130A.

Furthermore, in addition to the tactile sensation corresponding to the movement of the pointer 130A to the right and left directions, the tactile sensation corresponding to the movement of the pointer 130A to the front and back directions can be provided, when the pointer 130A touches the article.

For example, when the pointer 130A approaches the article 111 from the right side and the left front side of the pointer 130A touches the article 111, the vibrating element 133L1 disposed on the front left side of the operation terminal device 130B may be driven.

When the rear left side of the pointer 130A touches the article 111, the vibrating element 133L2 disposed on the rear left side of the operation terminal device 130B may be driven.

When the pointer 130A approaches the article 111 from the left side and the front right side of the pointer 130A touches the article 111, the vibrating element 133R1 disposed on the front right side of the operation terminal device 130B may be driven.

When the rear right side of the pointer 130A touches the article 111, the vibrating element 133R2 disposed on the rear right side of the operation terminal device 130B may be driven.

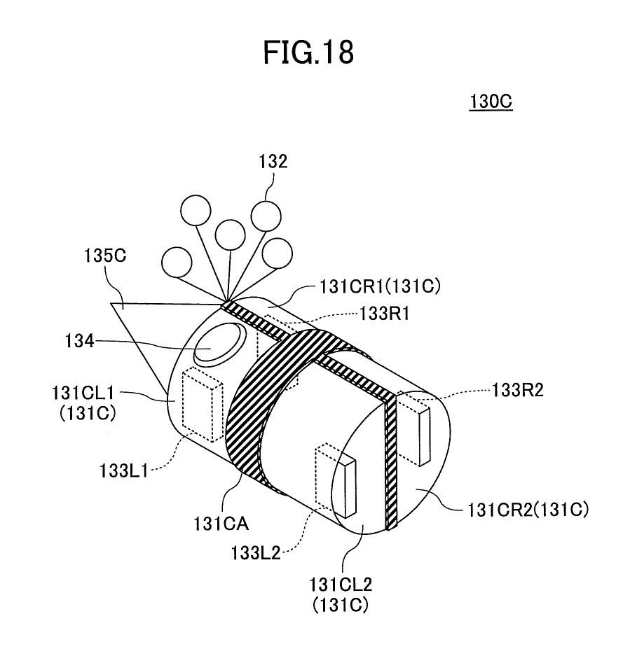

An operation terminal device 130C illustrated in FIG. 18 is made by changing the shape of the operation terminal device 130B illustrated in FIG. 17 to cylindrical. Other configurations of the operation terminal device 130C are similar to those of the operation terminal device 130B illustrated in FIG. 17. Therefore in the following description, the same symbol is attached to the same component, and repeated explanation about the same component is omitted.

The operation terminal device 130C includes a housing 131C, a marker 132, vibrating elements 133R1, 133R2, 133L1 and 133L2, a button 134, and a guide bar 135C.

The housing 131C includes housing parts 131CR1, 131CR2, 131CL1, and 131CL2, and an isolating member 131CA. The housing parts 131CR1, 131CR2, 131CL1, and 131CL2 are made by dividing a cylindrical member in half in a direction orthogonal to a center axis (a first half corresponds to the combination of the housing parts 131CR1 and 131CL1, and a second half corresponds to the housing parts 131CR2 and 131CL2) and further dividing both of the divided cylindrical members in half along the center axis.

Vibrating elements 133R1, 133R2, 133L1, and 133L2 are respectively provided in the housing parts 131CR1, 131CR2, 131CL1, and 131CL2.

The isolating member 131CA is a wall-like member, which is a cross-shaped member in a planar view and is disposed among the housing parts 131CR1, 131CR2, 131CL1, and 131CL2 as if the housing parts 131CR1, 131CR2, 131CL1, and 131CL2 were divided by the isolating member 131CA. The housing parts 131CR1, 131CR2, 131CL1, and 131CL2 are fixed on the isolating member 131CA such that vibrations occurring in each of the housing parts 131CR1, 131CR2, 131CL1, and 131CL2 are not propagated to each other.

That is, the housing parts 131CR1, 131CR2, 131CL1, and 131CL2 are separate components, and are connected via the isolating member 131CA to each other. The isolating member 131CA is a vibration-proof rubber member, for example. A vibration-proof rubber having a high damping ratio may be used for the isolating member 131CA.

By using the operation terminal device 130C, more types of tactile sensations can be provided in accordance with the part or the material of the article touched by the pointer 130A.

Furthermore, in addition to the tactile sensation corresponding to the movement of the pointer 130A to the right and left direction, the tactile sensation corresponding to the movement of the pointer 130A to the front and back direction can be provided, when the pointer 130A touches the article.

The cylindrical housing 131C may be designed such that the size of the housing 131C becomes similar to the size of a pen, a screwdriver, or various types of members.

Further, a method of driving the vibrating elements 133R1, 133R2, 133L1, and 133L2 is similar to that of the operation terminal device 130B illustrated in FIG. 17.

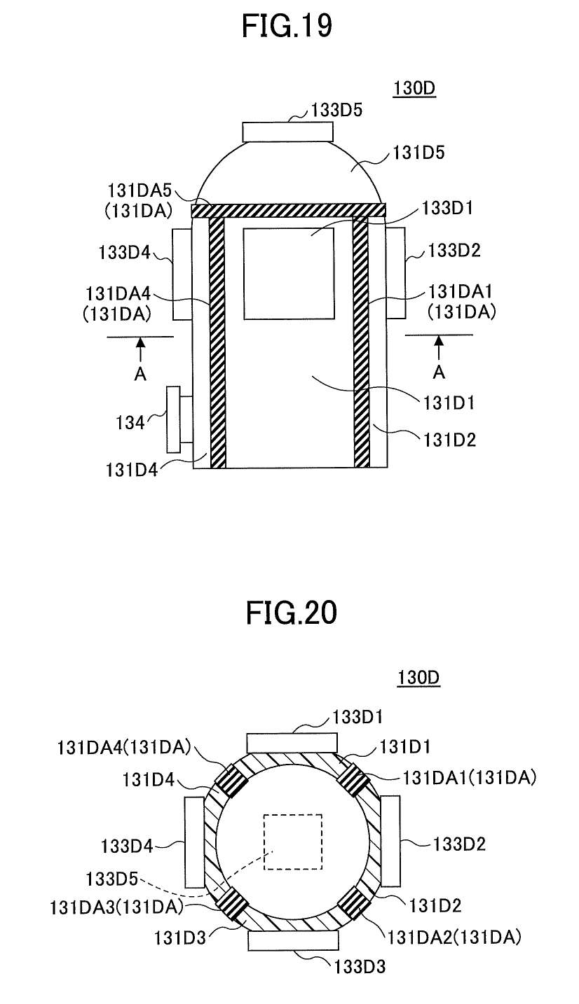

An operation terminal device 130D illustrated in FIGS. 19 to 21 is made by changing the operation terminal device 130C illustrated in FIG. 18 into a shape wearable on the user's finger.

Other configurations of the operation terminal device 130D are similar to the operation terminal device 130C illustrated in FIG. 18. Therefore in the following description, the same symbol is attached to the same component, and repeated explanation about the same component is omitted.

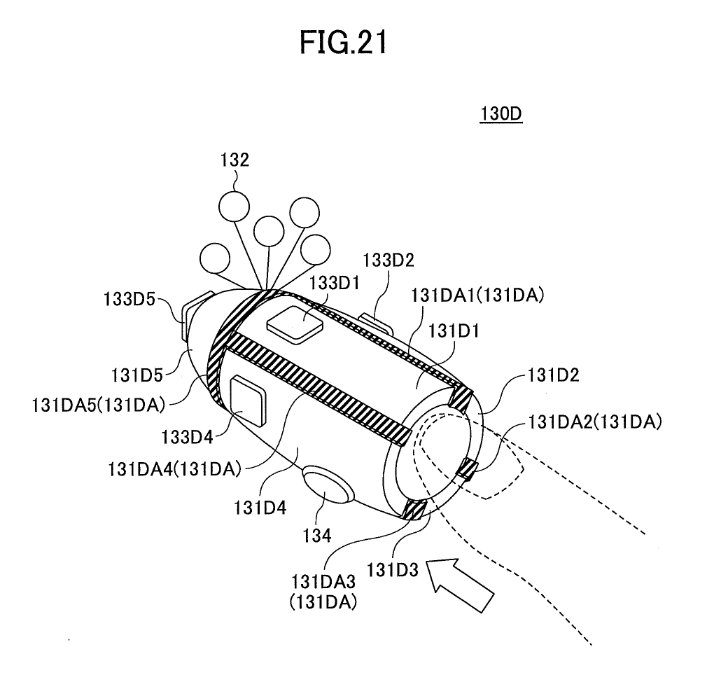

FIG. 19 is a plan view of the operation terminal device 130D, and FIG. 20 is a cross-sectional view taken along a line A-A in FIG. 19. FIG. 21 is a perspective view of the operation terminal device 130D seen from the rear left direction of the operation terminal device 130D. Note that illustrations of the marker 132 are omitted in FIGS. 19 and 20.

The operation terminal device 130D includes a housing 131D, a marker 132, vibrating elements 133D1, 133D2, 133D3, 133D4, and 133D5, and a button 134. When the user uses the operation terminal device 130D, he/she wears the operation terminal device 130D on his/her finger. The structure of the operation terminal device 130D is different from the operation terminal device 130C in that the guide bar 135C is not included in the operation terminal device 130D.

The housing 131D includes housing parts 131D1, 131D2, 131D3, 131D4, and 131D5, and an isolating member 131DA. The housing parts 131D1, 131D2, 131D3, and 131D4 are made by dividing a cylindrical member having a hole in which a finger can be inserted into four parts along a center axis. Further the housing part 131D5 is made by separating, from the cylindrical member, an end portion (front side of the operation terminal device 130D) of the cylindrical member.

The housing parts 131D1, 131D2, 131D3, 131D4, and 131D5 are separated from each other.

Vibrating elements 133D1, 133D2, 133D3, 133D4, and 133D5 are respectively disposed on outer surfaces of the housing parts 131D1, 131D2, 131D3, 131D4, and 131D5.

Further, the isolating member 131DA includes isolating pieces 131DA1, 131DA2, 131DA3, 131DA4, and 131DA5.

The isolating pieces 131DA1, 131DA2, 131DA3, and 131DA4 are respectively disposed between the housing parts 131D1 and 131D2, between the housing parts 131D2 and 131D3, between the housing parts 131D3 and 131D4, and between the housing parts 131D4 and 131D1. The isolating pieces 131DA1, 131DA2, 131DA3, and 131DA4, and the housing parts 131D1, 131D2, 131D3, and 131D4, constitute a cylindrical body having a hole in which a finger can be inserted.

The housing part 131D5 is attached at the front end of the cylindrical body via the isolating piece 131DA5 so that the hole at the front end of the cylindrical body is closed with the housing part 131D5.

The isolating member 131DA is disposed as if the housing parts 131D1, 131D2, 131D3, and 131D4 were divided by the isolating member 131DA. The housing parts 131D1, 131D2, 131D3, and 131D4 are fixed to the isolating member 131DA such that vibrations occurring in each of the housing parts 131D1, 131D2, 131D3, and 131D4 are not propagated to each other.

The isolating pieces 131DA1, 131DA2, 131DA3, 131DA4, and 131DA5 are vibration-proof rubber members, for example. A vibration-proof rubber having a high damping ratio may be used for the isolating pieces 131DA1, 131DA2, 131DA3, 131DA4, and 131DA5.

By wearing the operation terminal device 130D on the user's finger, the user can perceive tactile sensations from various directions (from left, right, up, down, and forward) in accordance with the part or the material of the article touched by the pointer 130A.

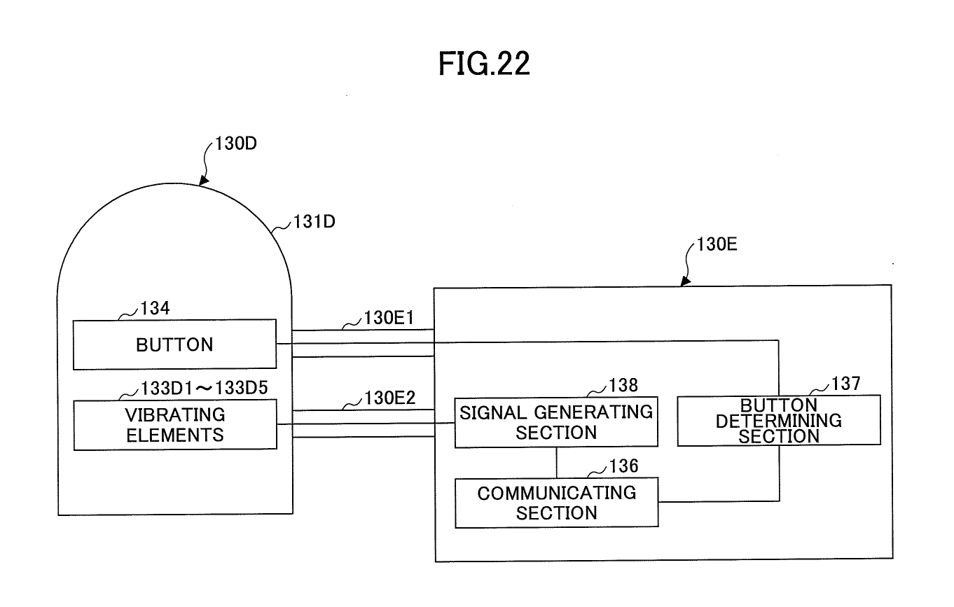

FIG. 22 is a diagram illustrating a configuration of an electrical system in the operation terminal device 130D. The operation terminal device 130D is small since it is adapted to be worn on a finger. Therefore the electrical system is divided into a subsystem in the housing 131D and a subsystem in a controller 130E. In the following description, the same symbol is attached to the component that is the same as the component in the electrical system illustrated in FIG. 6. Also, the explanation about the same component is omitted.

The vibrating elements 133D1, 133D2, 133D3, 133D4, and 133D5, and the button 134 are provided to the housing 131D. Further, the controller 130E includes a communicating section 136, a button determining section 137, and a signal generating section 138.

The button 134 is connected with the button determining section 137 via a cable 130E1, and the signal generating section 138 is connected to the vibrating elements 133D1, 133D2, 133D3, 133D4, and 133D5 via five cables 130E2. For convenience, in FIG. 22, only a single cable is illustrated for expressing the cables 130E2.

The operation terminal device 130D is small since it is adapted to be worn on a finger. Therefore when an entire electrical system cannot be stored in the housing 131D, the electrical system of the operation terminal device 130D may be configured such that the electrical system is divided into the subsystem in the housing 131D and the subsystem in the controller 130E.

Further, the configuration in which a part of the electrical system is disposed outside the housing may also be adopted in the operation terminal device 130, 130B, 130C, or 130D.

### Second Embodiment

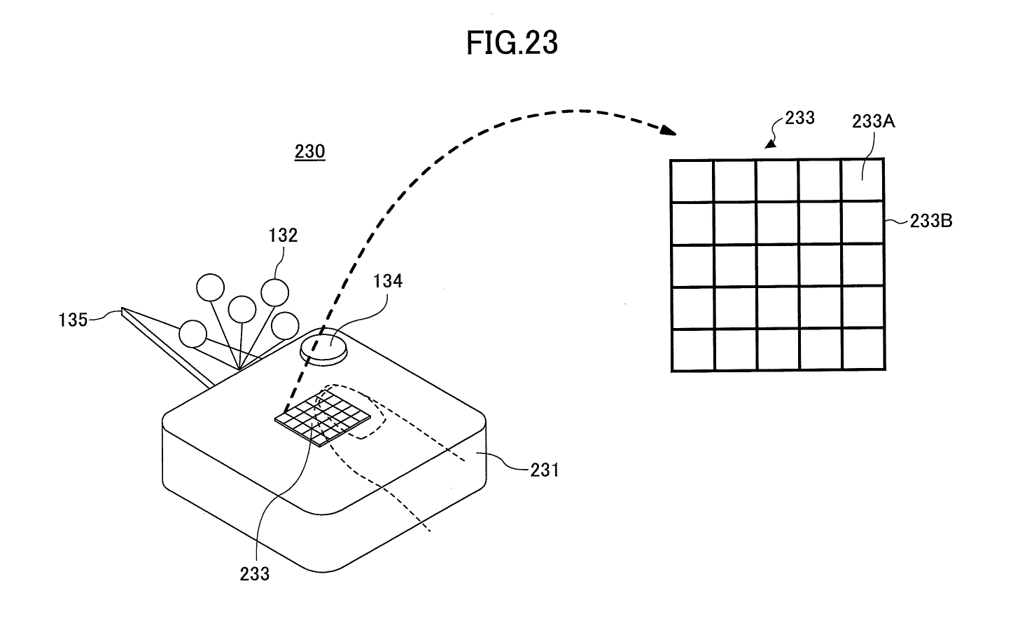

FIG. 23 is a perspective view illustrating an operation terminal device 230 according to a second embodiment.

The operation terminal device 230 includes a housing 231, a marker 132, a vibrating element 233, a button 134, and a guide bar 135. In the following description, with respect to the components that are the same as the components in the operation terminal device 130 according to the first embodiment, the same symbols are attached and the explanation about the components is omitted.

The major difference between the operation terminal device 230 and the operation terminal device 130 in the first embodiment is in structure of the vibrating element 233 and the housing 231.

The housing 231 is a box-shaped housing on which the vibrating element 233 and the button 134 are disposed. The housing 231 is made of resin for example, and has a size suitable for the user holding in his/her hand. The marker 132 and the guide bar 135 are attached to a front side of the housing 231.

A magnified plan view of the vibrating element 233 is illustrated at the right side of FIG. 23. As illustrated in the magnified plan view, the vibrating element 233 includes 25 units of actuators 233A which are arranged in a 5×5 matrix. Each of the actuators 233A may be, for example, an element containing a piezoelectric element or an LRA. The actuators 233A can be driven independently.

The 25 units of actuators 233A are separated by an isolating member 233B, such that vibrations occurring in each of the actuators 233A are not propagated each other. The isolating member 233B is a vibration-proof rubber member, for example. A vibration-proof rubber having a high damping ratio may be used for the isolating member 233B.

This operation terminal device 230 is used for operating a pointer 130A, similar to the operation terminal device 130 according to the first embodiment.

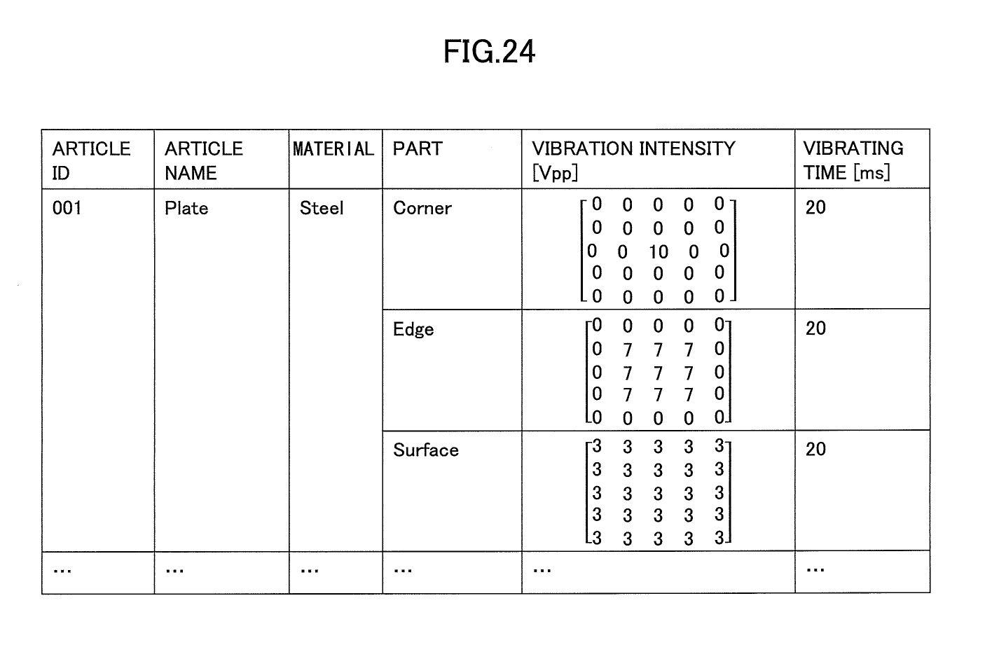

FIG. 24 is a diagram illustrating a vibration data according to the second embodiment.

The vibration data includes an article ID, an article name, a material, a part name, vibration intensity, and a vibrating time. The article ID, the article name, the material, the part name, the vibration intensity, and the vibrating time are similar information to those included in the vibration data illustrated in FIG. 7 which are described in the first embodiment.

The vibration intensity represents amplitudes (Vpp) of driving signals for driving the units of actuators 233A independently. The vibration intensity is represented as peak-to-peak voltage. As an example, the vibration intensity is defined such that the vibration intensity at “Corner” is the strongest, the vibration intensity at “Surface” is the weakest, and the vibration intensity at “Edge” is moderate.

To drive the 25 units of actuators 233A independently, the vibration intensity is represented as a 5×5 matrix, and each element in the 5×5 matrix represents an amplitude of a driving signal given to each actuator 233A.

For example, with respect to a part of an article whose article ID is 001, whose article name is “Plate”, whose material is “Steel”, and whose part name is “Corner”, the vibration data illustrated in FIG. 24 represents that one of the actuators 233A, the actuator unit located at the center of the 5×5 matrix, is driven at the vibration intensity of 10, and the vibrating time is 20 ms.

Also, with respect to a part of the article whose part name is “Edge”, the vibration data represents that 9 units of the actuators 233A constituting a 3×3 matrix located in the middle part of 5×5 matrix of the actuators 233A are driven at the vibration intensity of 7, and the vibrating time is 20 ms.

Also, with respect to a part of the article whose part name is “Surface”, the vibration data represents that all of the 25 units of actuators 233A are driven at the vibration intensity of 3, and the vibrating time is 20 ms.

In the present embodiment, as described here, tactile sensations associated with “Corner”, “Edge”, and “Surface” are expressed by driving different numbers of actuators 233A at different vibration intensities.

In the vibration data, as described here, the vibration intensity and the vibrating time are set for each part of an article to produce the tactile sensation that the user perceives in an actual space when he/she touches the surface of the article with his/her hand, by the vibration generated in the 25 units of actuators 233A.

Note that the vibration data is stored in the data storage section 124 of the processing apparatus 120.

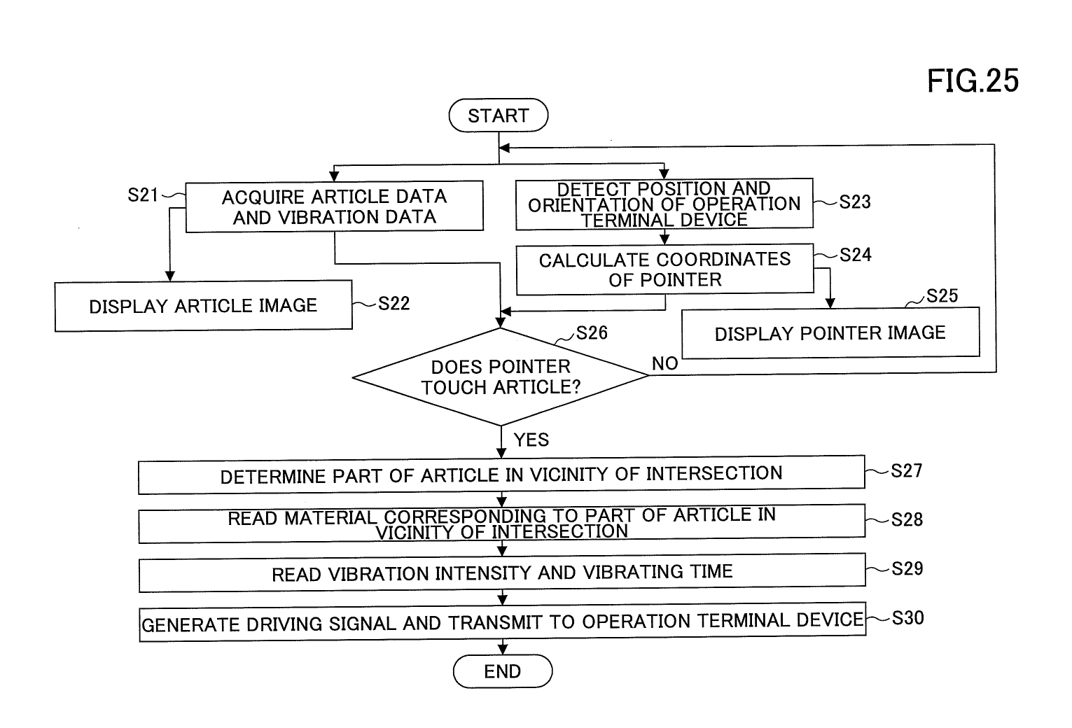

FIG. 25 is a flowchart describing the process performed in the processing apparatus 120 according to the second embodiment. Here, the case where articles 111 and 112 are displayed on the screen 110A will be described, as illustrated in FIG. 1.

The processing apparatus 120 starts processing after power-on (start).

Steps S21 to S26 are similar to the steps S1 to S6 illustrated in FIG. 11.

The flowchart illustrated in FIG. 25 does not include a step corresponding to the step S7 illustrated in FIG. 7, since the operation terminal device 230 according to the second embodiment does not provide a tactile sensation expressing from which direction the pointer 130A has come in contact with the article.

Therefore, after completing the step S26, steps S27 to S30 are performed. The steps S27 to S30 are similar to the steps S8 to S11 illustrated in FIG. 1, respectively. Major differences will be described in the following.

At step S29, the processing apparatus 120 reads, from the vibration data (refer to FIG. 24), the vibration intensity and the vibrating time corresponding to the part of the article 111 touched by the pointer 130A, by using the article ID of the article 111 that the pointer 130A touches and the part determined at step S27. Here, the processing apparatus 120 reads the driving signals corresponding to the 25 units of actuators 233A.

At step S30, the processing apparatus 120 generates driving signals for driving the 25 units of actuators 233A, and transmits the driving signals to the operation terminal device 230 via the communicating section 126. The actuators 233A of the operation terminal device 230 are driven accordingly.

By performing the process described above, the vibration intensity and the vibrating time of the 25 units of actuators 233A corresponding to the part or the material of the article are determined, so that the tactile sensation can be provided to the user according to the part or the material of the article.

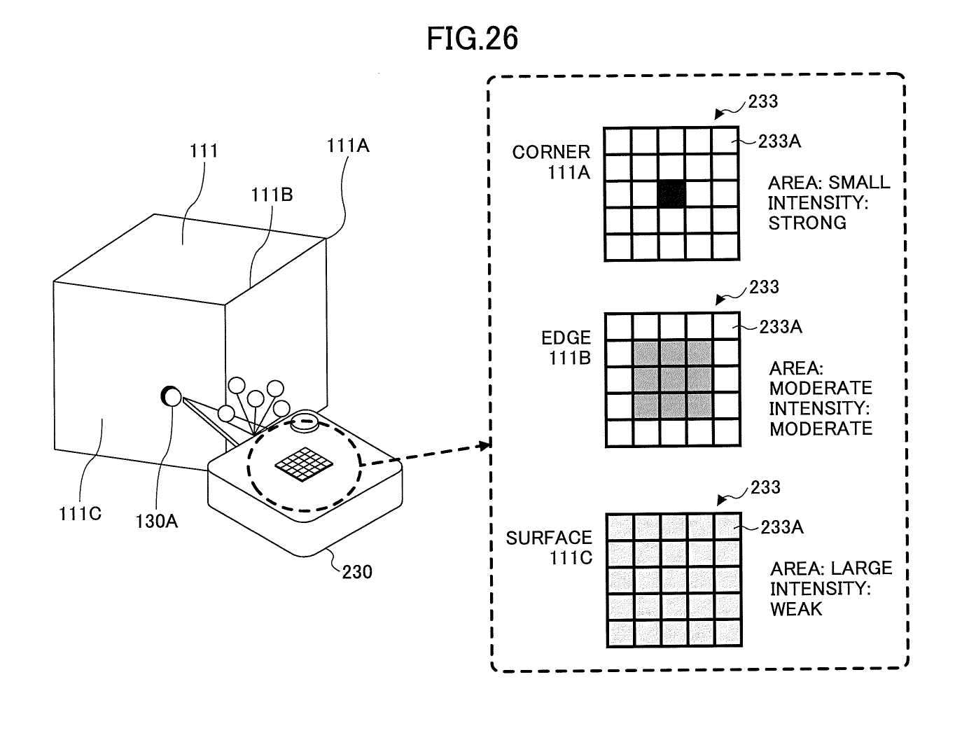

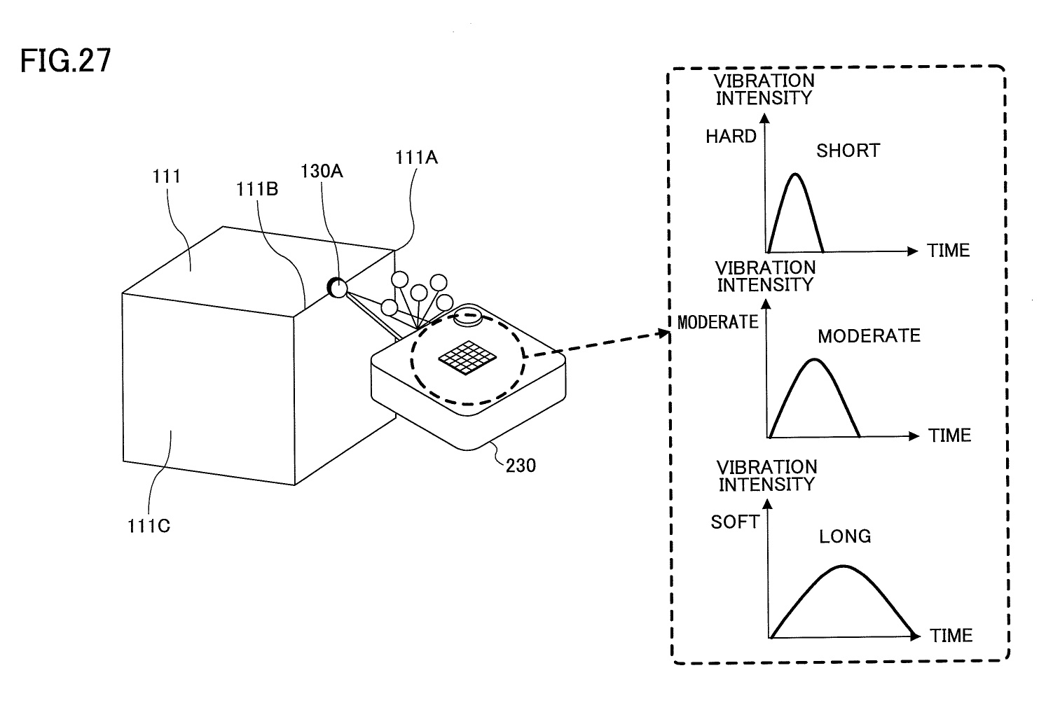

Next, with reference to FIGS. 26 and 27, the degree of the vibration intensity and the length of the vibrating time for driving the actuators 233A will be described. Here, the case where the pointer 130A touches the article 111 will be described, unless otherwise stated. The article 111 is simply an example of the articles that the simulation system 100 displays on the screen 110A. Therefore, the following description can also be applied to the case where the pointer 130A touches articles other than the article 111.

FIG. 26 is a drawing illustrating the relation between the part of the article 111 touched by the pointer 130A and the vibration pattern.

On the right side of FIG. 26, each cell represents one actuator 233A, and the actuator 233A to be driven is illustrated in gray. The larger the vibration intensity of the actuator 233A is, the darker gray is used to illustrate the cell. Here, to express the strength of the vibration intensity, three types of gray are used. The darkest gray cell represents that the vibration intensity of the actuator 233A corresponding to the cell is the strongest, the lightest gray represents that the vibration intensity of the actuator 233A corresponding to the cell is the weakest, and the moderate gray represent that the vibration intensity is moderate. Note that the actuator 233A which is not driven is represented as a white cell.

When the pointer 130A touches the corner 111A, the actuator 233A located in the center of the units of actuators 233A is driven at the strongest (largest) vibration intensity (amplitude).

When the pointer 130A touches the edge 111B, 9 units of the actuators 233A located in the middle part of the 25 units of actuators 233A are driven at moderate vibration intensity (amplitude).

When the pointer 130A touches the surface 111C, all of the 25 units of actuators 233A are driven at the weakest (smallest) vibration intensity (amplitude).

As described above, the number of the actuators 233A to be driven and the vibration intensity is changed depending on which part of the article 111 is touched by the pointer 130A among the corner 111A, the edge 111B, and the surface 111C.

As described above, for example, by changing the number of the actuators 233A to be driven and the vibration intensity depending on the part of the article, the simulation system 100 can provide the tactile sensation to the user who operates the pointer 130A of the operation terminal device 230 according to the part of the article 111 touched by the pointer 130A.

FIG. 27 is a drawing illustrating the relation between the material of the article 111 touched by the pointer 130A and the vibration pattern.

In FIG. 27, an example for changing the vibrating time depending on the material of the article such as the article 111 or 112 is illustrated.

As described in the first embodiment, the vibration data depending on the Young's modulus is prepared in advance. In the following description for example, the following definitions are used. A material having a Young's modulus not less than 10 GPa is a hard material, a material having a Young's modulus between 1 GPa and 10 GPa is a moderate material, and a material having a Young's modulus not more than 1 GPa is a soft material.

When the material of the article touched by the pointer 130A is hard, the simulation system 100 shortens the vibrating time. At this time, only one actuator 233A located at the center of the 25 units of the actuators 233A may be driven.

When the material of the article touched by the pointer 130A has moderate hardness, the simulation system 100 sets the vibrating time moderately. Also at this time, 9 units of the actuators 233A located in the middle part of the 25 units of the actuators 233A may be driven.

Further, when the material of the article touched by the pointer 130A is soft, the simulation system 100 makes the vibrating time longer. In this case, all of the 25 units of actuators 233A may be driven.

As described here, by changing the vibrating time depending on the material of the article touched by the pointer 130A, the simulation system 100 can provide the tactile sensation to the user who operates the pointer 130A of the operation terminal device 230 according to the part of the article 111 touched by the pointer 130A.

A combination of the method of changing the vibration intensity in accordance with the part of the article as described in FIG. 26 and the method of changing the vibrating time in accordance with the material of the article as described in FIG. may be used. By using a combination of these methods, the vibration pattern can be changed in accordance with the part and the material of the article.

As described above, in the simulation system according to the second embodiment, when the pointer 130A operated by the operation terminal device 230 touches an article such as the article 111 or 112 in the image projected on the screen 110A, the simulation system changes the vibration pattern to vibrate the actuators 233A in accordance with the part or material of the article touched by the pointer 130A.

Since the simulation system can provide the tactile sensation to the user according to the part or the material of the article, the user can recognize the difference of the part or the material of the article only by the tactile sensation.

As described above, the simulation system according to the second embodiment can provide the tactile sensation to the user according to the part or the material of the article. These tactile sensations simulatively represent the sensation that the user is touching the article with his/her hand in actual space, with very high reality.

Hence, the second embodiment can provide the simulation system that can provide a realistic tactile sensation.

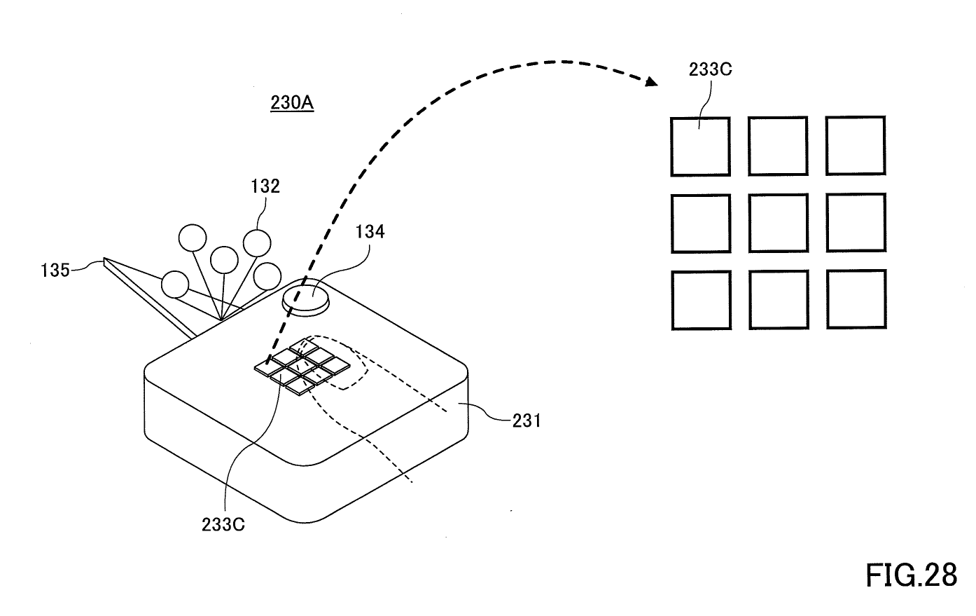

Next, with reference to FIGS. 28 to 33, some modified examples of the second embodiment will be described.

FIGS. 28 to 33 are drawings illustrating modified examples of the second embodiment.

An operation terminal device 230A illustrated in FIG. 28 is made by replacing the vibrating element 233 of the operation terminal device 230 illustrated in FIG. 23 with a vibrating element 233C. The vibrating element 233C includes 9 units of actuators which are arranged in a 3×3 matrix. Each actuator is similar to the actuator 233A illustrated in FIG. 23.

The vibrating element 233C does not include the isolating member 233B, which is different from the vibrating element 233 of the operation terminal device 230 illustrated in FIG. 23.

The operation terminal device 230A may be used instead of the operation terminal device 230 illustrated in FIG. 23.

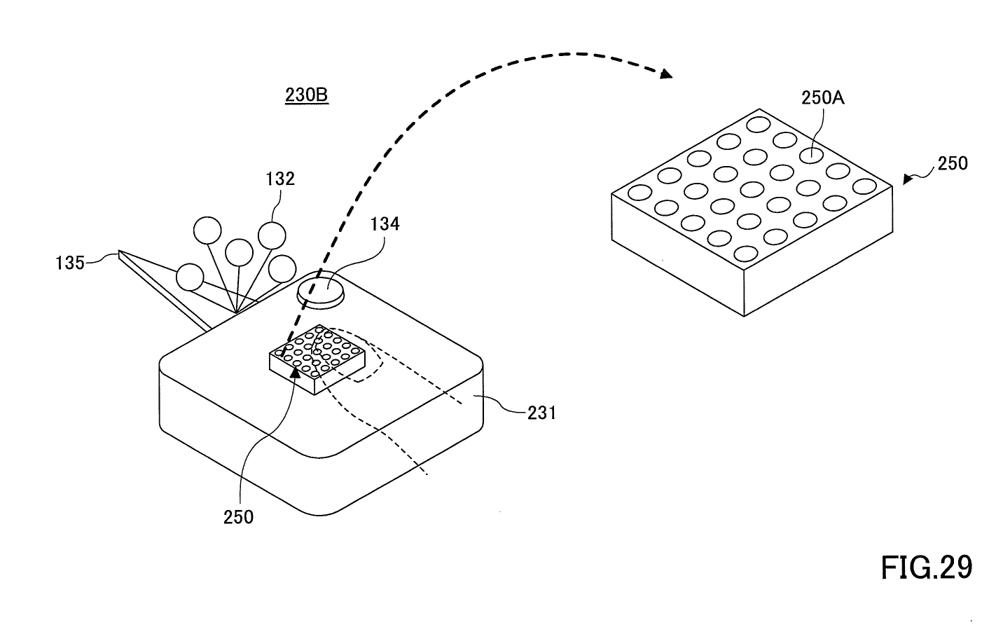

An operation terminal device 230B illustrated in FIG. 29 is made by changing the vibrating element 233 of the operation terminal device 230 illustrated in FIG. 23 into a suction element 250. The suction element 250 includes 25 units of suction ports 250A which are arranged in a 5×5 matrix. At the bottom of each suction port 250A, a suction mechanism like a vacuum apparatus for sucking is connected.

The suction ports 250A are separately arranged each other, and each suction mechanism operates independently. In controlling the suction element 250, the number of suction ports 250A may be controlled in a way similar to the way to control the number of the actuators 233A illustrated in FIG. 23. Also the strength of suction may be controlled similarly to the vibration intensity of the actuators 233A illustrated in FIG. 23.

The operation terminal device 230B may be used instead of the operation terminal device 230 illustrated in FIG. 23.

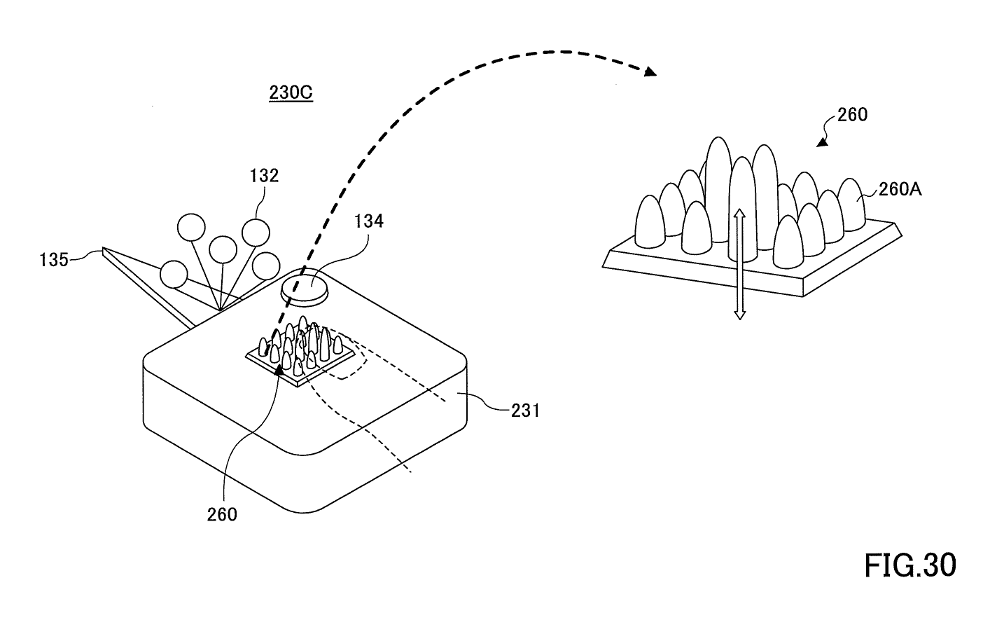

An operation terminal device 230C illustrated in FIG. 30 is made by replacing the vibrating element 233 of the operation terminal device 230 illustrated in FIG. 23 with a movable element 260. The movable element 260 includes 16 movable pins 260A which are arranged in a 4×4 matrix. At the back side of each movable pin 260A, an actuator for moving the movable pin 260A up and down is disposed.

The movable pins 260A are separately arranged from each other, and each actuator operates independently. In controlling the movable element 260, the number of movable pins 260A may be controlled in a way similar to the way to control the number of the actuators 233A illustrated in FIG. 23. Also the force of moving the movable pin 260A or the height of the movable pin 260A may be controlled similarly to the vibration intensity of the actuators 233A illustrated in FIG. 23.

The operation terminal device 230C may be used instead of the operation terminal device 230 illustrated in FIG. 23.

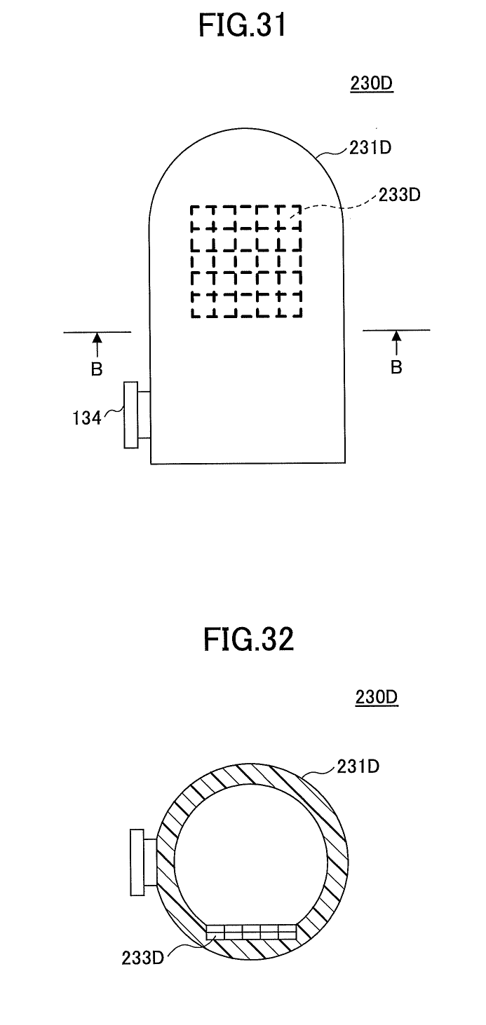

An operation terminal device 230D illustrated in FIGS. 31 to 33 is configured to be adapted to be worn on the user's finger, similar to the operation terminal device 130D illustrated in FIGS. 19 to 21.

FIG. 31 is a plan view of the operation terminal device 230D, and FIG. 32 is a cross-sectional view taken along a line B-B in FIG. 31.

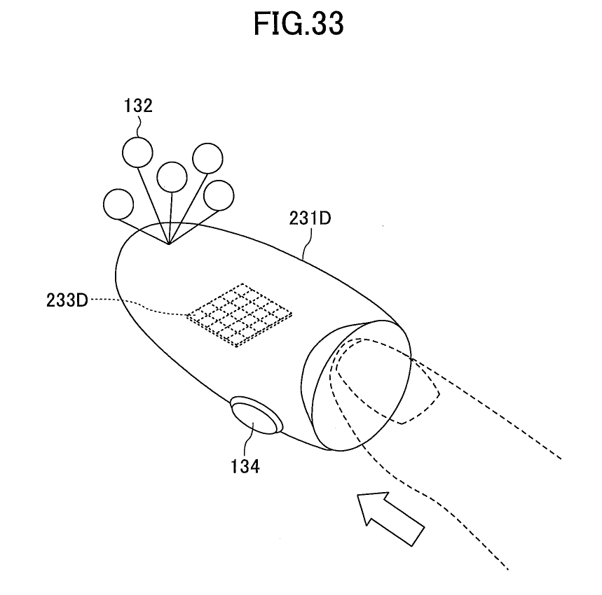

FIG. 33 is a perspective view of the operation terminal device 230D seen from rear left direction. Note that illustrations of the marker 132 are omitted in FIGS. 31 and 32.

The operation terminal device 230D includes a housing 231D, a marker 132, a vibrating element 233D, and a button 134.

The housing 231D is a cylindrical member having a hole in which a finger can be inserted, and an end part of the cylindrical member is closed.

Inside the housing 231D, the vibrating element 233D is disposed so that the vibrating element 233D can be touched by a pad of a user's fingertip.

By wearing the operation terminal device 230D on the user's finger, the user can sense a tactile sensation in accordance with the part or the material of the article touched by the pointer 130A.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. A simulation system comprising:
a display section configured to display an image of an article based on article data representing a shape and coordinates of the article;
an operation terminal device including a plurality of dynamic elements, the operation terminal device being configured to be used by a user holding the operation terminal device with a hand to operate a position of a pointer displayed on the display section by moving the operation terminal device;
a data storage section configured to store the article data and vibration data, the vibration data representing vibration patterns for vibrating the plurality of dynamic elements, each of the vibration patterns corresponding to a tactile sensation associated with a different part or a different material of the article;
a first detecting section configured to detect a position and an orientation of the operation terminal device;
a second detecting section configured to calculate coordinates of the pointer displayed on the display section, based on the position and the orientation of the operation terminal device;
a determining section configured to make a determination whether the pointer has come in contact with the article displayed on the display section, based on the coordinates included in the article data and the coordinates of the pointer detected by the second detecting section; and
a drive controlling section configured to drive the plurality of dynamic elements, the plurality of dynamic elements being driven in accordance with a vibration pattern included in the vibration data corresponding to a part or a material of the article touched by the pointer, in response to the determination that the pointer has come in contact with the article.

2. The simulation system according to claim 1, wherein the determining section determines that the pointer has come in contact with the article when distance between a position of the article displayed on the display section and the position of the pointer is not more than a given value.

3. The simulation system according to claim 1, wherein the determining section determines a side from which the pointer has come in contact with the article, and wherein the drive controlling section drives the dynamic element located at a same side as a side of the article relative to the pointer.

4. The simulation system according to claim 1, wherein the vibration data includes, for each part or material of the article, one of a vibration intensity to drive the dynamic element, a time to drive the dynamic element, and a number of the dynamic elements to be driven in accordance with the vibration pattern.

5. The simulation system according to claim 4, wherein an area on the operation terminal device for expressing the tactile sensation is determined by the number of the dynamic elements to be driven in accordance with the vibration pattern.

6. The simulation system according to claim 1, further comprising a processing apparatus including the second detecting section, the drive controlling section, and a first communicating section,
wherein the operation terminal device further comprises a second communicating section configured to perform wireless communication with the first communicating section, and
the plurality of dynamic elements are driven based on a driving instruction received from the processing apparatus via the wireless communication, the driving instruction being output by the drive controlling section.

7. The simulation system according to claim 1, wherein the plurality of dynamic elements are a plurality of vibrating elements, and
the operation terminal device further comprises a plurality of base units, the plurality of vibrating elements respectively being provided on the plurality of base units, and an isolating member provided between the plurality of base units to cut off vibration.

8. The simulation system according to claim 1, wherein the plurality of dynamic elements are one of the following:
a plurality of driving elements arranged on a surface of the operation terminal device which the user touches, each of the plurality of driving elements projecting from a nested configuration, and
a plurality of suction mechanisms and suction ports arranged on a surface of the operation terminal device which the user touches, each of the suction mechanisms being connected to one of the suction ports and configured to perform suction.
